(19) United States
(12) Patent Application Publication
(10) Pub. No.: US 2025/0373486 A1
(43) Pub. Date: Dec. 4, 2025

(54) CLUSTER FAILURE MANAGEMENT SYSTEM AND TECHNIQUES FOR TELECOMMUNICATIONS SYSTEMS

(71) Applicant: DISH Wireless L.L.C., Littleton, CO (US)

(72) Inventors: Premchand Chandran, Ashburn, VA (US); Gurpreet Sohi, Parker, CO (US); Julio Armenta, Aldie, VA (US)

(21) Appl. No.: 18/680,392

(22) Filed: May 31, 2024

(51) Int. Cl. H04L 41/0663; H04W 24/04

(52) U.S. Cl. CPC H04L 41/0663; H04W 24/04

(57) ABSTRACT

Techniques for cluster failure management in telecommunications systems are provided. In one example, a cellular network includes: a first radio unit (RU) that supports a first cell of the network, a second RU that supports a second cell, and a server system in communication with both RUs. The server system comprises a first server and a second server. A first pod acting as a distributed unit for the first RU is active on the first server and instantiated on the second server. A second pod acting as a distributed unit for the second RU is instantiated on the first server and active on the second server. A control plane executing on the first server manages execution of both pods, in response to determining that a pod is no longer active on a server, activates the pod on the other server.

### FIELD

The present invention generally relates to communications, and more specifically, to cluster failure management for telecommunications systems.

### BACKGROUND

Mobile telecommunications networks include Radio Access Networks (RANs) and a network core. RANs belonging to 4G are known as Long Term Evolution (LTE) and RANs belonging to 5G are known as New Radio (NR), which has been standardized to allow tight interworking with LTE. The RAN includes antennae seen on cellular telecommunications towers and other locations (e.g., on top of buildings, in stadiums, etc.). When a cellular telephone call is made via a mobile device or a Short Message Service (SMS) message is sent, for example, antenna(s) of the RAN transmit signals to and receive signals from the mobile device. The RAN base station also digitizes the signals from the mobile device and sends this information to the network core.

In an Open RAN (O-RAN) architecture, the RAN includes three main building blocks: the Radio Unit (RU), the Distributed Unit (DU), and the Centralized Unit (CU). The RUs transmit, receive, amplify, and digitize radio frequency signals. RUs are located near, or integrated into, an antenna of the cellular telecommunications tower, and are operably connected to the antenna. Each cellular telecommunications tower may have multiple RUs to fully service various bands for a particular coverage area. The DU receives the digitized radio signals from the RU(s) via a Cellular Site Router (CSR) that routes traffic from the RUs to the DU and sends the digitized radio signal to the CU for further processing. The DU is usually physically located at or near the RU, whereas the CU can be located nearer to the network core (e.g., in a Pass-through Edge Data Center (PEDC) or a Breakout Edge Data Center (BEDC)).

The key concept of O-RAN is “opening” the protocols and interfaces between the various building blocks (i.e., radios, hardware, and software) in the RAN. The O-RAN Alliance has defined various interfaces within the RAN, including those for fronthaul between the RU and the DU, midhaul between the DU and the CU, and backhaul connecting the RAN to the network core. The CU accommodates the higher protocol stack layers while the DU accommodates the lower protocol stack layers.

DUs are the main processing units that are responsible for the High Physical, Media Access Control (MAC), and Radio Link Control (RLC) protocols in the RAN protocol stack under the Third Generation Partnership Project (3GPP). In other words, DUs are a logical encapsulation of the 3GPP stack. In O-RAN or virtualized RAN (vRAN), DUs are typically servers based on an Intel® architecture that are optimized to run the real time RAN functions located below split 2 and to connect with the RUs through a fronthaul interface based on O-RAN split 7-2x. DUs perform Layer 1 (L1) and Layer 2 (L2) processing.

Kubernetes® may be used for DUs to provide a portable, extensible, open source platform for managing containerized workloads and services that facilitates both declarative configuration and automation. Containers are similar to Virtual Machines (VMs). However, they have relaxed isolation properties to share the Operating System (OS) among the applications. Therefore, containers are considered lightweight. Similar to a VM, a container has its own file system, a share of Central Processing Unit (CPU) resources, memory, process space, etc. Since containers are decoupled from the underlying infrastructure, they are portable across clouds and OS distributions.

In such virtualized, containerized DU implementations, individual pods representing one or more running containers in a cluster or the nodes themselves may fail. This could impair the RAN for hours or days until an engineer or technician is able to address the cause of the failure. Accordingly, an improved and/or alternative approach to DU management for virtualized, containerized architectures may be beneficial.

### SUMMARY

Certain embodiments of the present invention may provide solutions to the problems and needs in the art that have not yet been fully identified, appreciated, or solved by current communications technologies, and/or provide a useful alternative thereto. For example, some embodiments of the present invention pertain to cluster failure management for telecommunications systems.

In some embodiments, a cellular network is provided. The cellular network may include a first radio unit configured to support a first cell of the cellular network. The cellular network may further include a second radio unit configured to support a second cell of the cellular network. The cellular network may further include a server system in communication with the first radio unit and the second radio unit. The server system may comprise a first server and a second server. In some embodiments, a first pod configured to act as a first distributed unit for the first radio unit is active on the first server and instantiated on the second server. In some embodiments, a second pod configured to act as a second distributed unit for the second radio unit is instantiated on the first server and active on the second server. In some embodiments, a control plane is executing on the first server, the control plane configured to manage execution of the first pod and the second pod by the first server and the second server. In some embodiments, the control plane activates the first pod on the second server in response to determining that the first pod is no longer active on the first server. In some embodiments, the control plane activates the second pod on the first server in response to determining that the second pod is no longer active on the second server.

In some embodiments, the cellular network further includes a public cloud-computing platform comprising a plurality of centralized units, wherein the server system is communicatively connected via a network with the public cloud-computing platform. In some embodiments, the public cloud-computing platform further comprises a network core that manages network functions for the cellular network.

In some embodiments, the control plane determines that a pod is no longer active on a server in response to determining that a predefined number of heartbeat messages were not received from the pod, that the heartbeat messages were not received for a predefined amount of time, or both. In some embodiments, the server system shares a persistent volume. In some embodiments, in response to determining that the first pod is no longer active on the first server, the control plane further deactivates the second pod on the second server and activates the second pod on the first server. In some embodiments, the control plane activates the first pod on the second server in further response to determining that the first pod cannot be reactivated on the first server. In some embodiments, the control plane activates the second pod on the first server in further response to determining that the second pod cannot be reactivated on the second server.

In some embodiments, the control plane executing on the first server is a first instance, a second instance of the control plane is executing in standby on the second server, the second instance of the control plane monitors execution of the control plane on the first server, and the second instance of the control plane begins to manage the execution of the first pod and the second pod in response to determining that the first instance of the control plane is no longer executing on the first server. In some embodiments, the second instance of the control plane activates the first pod on the second server in response to determining that the first server is no longer available. In some embodiments, the first instance of the control plane monitors execution of the second instance of the control plane on the second server, and the first instance of the control plane executes a new instance of the control plane on the second server in response to determining that the second instance of the control plane is no longer executing on the second server.

In some embodiments, the cellular network further includes an orchestration server system running an orchestrator application configured to monitor execution of the control plane on the first server. In some embodiments, the orchestrator application instantiates a copy of the control plane on the second server in response to determining that the control plane is no longer executing on the first server. In some embodiments, the orchestrator application instantiates the copy of the control plane on the second server in further response to determining that a new instance of the control plane cannot be executed on the first server. In some embodiments, the orchestrator application activates the first pod on the second server in response to determining that the first server is no longer available. In some embodiments, the first server and the second server are virtual machines executed by the server system.

In some embodiments, a method for managing distributed units in a cellular network is provided. The method may comprise operating a first radio unit to support a first cell of the cellular network. The method may further comprise operating a second radio unit to support a second cell of the cellular network. The method may further comprise instantiating, on a cloud-computing platform, a plurality of centralized units. The method may further comprise operating a server system comprising a first server, a second server, and a radio unit interface. In some embodiments, the first radio unit and the second radio unit are connected to the radio unit interface of the server system and the server system is connected with the cloud-computing platform via a network. The method may further comprise executing a first pod on the first server. In some embodiments, the first pod executes a first distributed unit software package that configures the first pod to transmit data between the first radio unit and the plurality of centralized units via the radio unit interface. The method may further comprise instantiating the first pod in standby on the second server. The method may further comprise executing a second pod on the second server. In some embodiments, the second pod executes a second distributed unit software package that configures the second pod to transmit data between the second radio unit and the plurality of centralized units via the radio unit interface. The method may further comprise instantiating the second pod in standby on the first server. The method may further comprise executing a control plane on the first server. In some embodiments, the control plane manages execution of the first pod and the second pod. In some embodiments, the control plane activates the first pod on the second server in response to determining that the first pod is no longer executing on the first server. In some embodiments, the control plane activates the second pod on the first server in response to determining that the second pod is no longer executing on the second server.

In some embodiments, in response to determining that the first pod is no longer active on the first server, the control plane further deactivates the second pod on the second server and activates the second pod on the first server. The method may further comprise operating an orchestration server system running an orchestrator application. In some embodiments, the orchestrator application monitors execution of the control plane on the first server and instantiates a copy of the control plane on the second server in response to determining that the control plane is no longer executing on the first server.

In some embodiments, a distributed unit is provided. The distributed unit may comprise a server system in communication with a first radio unit configured to support a first cell of a cellular network and a second radio unit configured to support a second cell of the cellular network. In some embodiments, the server system comprises a first server and a second server. In some embodiments, a first pod configured to act as a first distributed unit for the first radio unit is active on the first server and instantiated on the second server. In some embodiments, a second pod configured to act as a second distributed unit for the second radio unit is instantiated on the first server and active on the second server. In some embodiments, a control plane configured to manage execution of the first pod and the second pod by the first server and the second server is executing on the first server. In some embodiments, the control plane activates the first pod on the second server in response to determining that the first pod is no longer active on the first server. In some embodiments, the control plane activates the second pod on the first server in response to determining that the second pod is no longer active on the second server.

In some embodiments, the first server and the second server are virtual machines executed by the server system. In some embodiments, the control plane activates the first pod on the second server in further response to determining that the first pod cannot be reactivated on the first server, and the control plane activates the second pod on the first server in further response to determining that the second pod cannot be reactivated on the second server.

In some embodiments, a cellular network is provided. The cellular network may comprise a base station comprising a radio unit and an antenna. The cellular network may further comprise a first server in communication with the radio unit. In some embodiments, a pod performing distributed unit (DU) functions is executing on the first server and a control plane managing execution of the pod is executing on the first server. The cellular network may further comprise a second server communicatively connected to the radio unit at the base station. The cellular network may further comprise an orchestration server system in communication with the first server and the second server. In some embodiments, an orchestrator application executing on the orchestration server system monitors execution of the control plane on the first server. In some embodiments, in response to determining that the control plane is no longer executing on the first server, the orchestrator application activates a new instance of the control plane on the second server to manage the execution of the pod.

In some embodiments, the orchestrator application determines that the control plane is no longer executing on the first server in response to determining that a predefined number of heartbeat messages were not received from the control plane, that the heartbeat messages were not received for a predefined amount of time, or both. The method may further comprise a public cloud-computing platform comprising a plurality of centralized units, wherein the first server and the second server are communicatively connected via a network with the public cloud-computing platform. In some embodiments, the public cloud-computing platform further comprises a network core that manages network functions for the cellular network.

In some embodiments, the orchestrator application activates the new instance of the control plane on the second server in further response to determining that the control plane cannot be reactivated on the first server. In some embodiments, the orchestrator application activates a new instance of the pod on the second server in response to determining that the first server is no longer available. In some embodiments, the orchestrator application configures the new instance of the control plane on the second server to manage the execution of the pod on the first server.

In some embodiments, the first server and the second server are virtual machines and the orchestrator application activates the second server as a new instance of the first server in response to determining that the first server cannot be reactivated. In some embodiments, the first server and the second server are located in different geographic locations within a predefined maximum distance from the base station. The cellular network may further comprise a plurality of servers comprising the first server and the second server, wherein the orchestrator application identifies the second server for instantiation of the new instance of the control plane from the plurality of servers by determining that a distance from the base station to the second server is less than a predefined maximum distance.

In some embodiments, a method for managing distributed units in a cellular network is provided. The method may comprise operating a first server in communication with a radio unit at a base station. In some embodiments, a pod performing distributed unit (DU) functions is executing on the first server and a control plane managing execution of the pod is executing on the first server. The method may further comprise operating a second server communicatively connected to the radio unit at the base station. The method may further comprise operating an orchestration server system in communication with the first server and the second server. In some embodiments, an orchestrator application executing on the orchestration server system monitors execution of the control plane on the first server. In some embodiments, in response to determining that the control plane is no longer executing on the first server, the orchestrator application activates a new instance of the control plane on the second server to manage the execution of the pod.

In some embodiments, the orchestrator application determines that the control plane is no longer executing on the first server in response to determining that a predefined number of heartbeat messages were not received from the control plane, that the heartbeat messages were not received for a predefined amount of time, or both. In some embodiments, the orchestrator application activates the new instance of the control plane on the second server in further response to determining that the control plane cannot be reactivated on the first server. In some embodiments, the orchestrator application activates a new instance of the pod on the second server in response to determining that the first server is no longer available. The method may further comprise identifying the second server for instantiation of the new instance of the control plane from a plurality of servers by determining that a distance from the base station to the second server is less than a predefined maximum distance.

In some embodiments, one or more non-transitory computer-readable media storing one or more instructions are provided which, when executed by one or more processors of a distributed unit orchestration server system, cause the one or more processors to monitor execution of a control plane on a first server in communication with the distributed unit orchestration server system. In some embodiments, the first server is in further communication with a radio unit at a base station, a pod performing distributed unit functions for the radio unit is executing on the first server, and the control plane manages execution of the pod. The one or more instructions may further cause the one or more processors to activate, in response to determining that the control plane is no longer executing on the first server, a new instance of the control plane on a second server to manage the execution of the pod.

The one or more instructions may further cause the one or more processors to determine that the control plane is no longer executing on the first server in response to determining that a predefined number of heartbeat messages were not received from the control plane, that the heartbeat messages were not received for a predefined amount of time, or both. The one or more instructions may further cause the one or more processors to determine that the control plane cannot be reactivated on the first server, wherein the new instance of the control plane is activated on the second server in further response to determining that the control plane cannot be reactivated on the first server. The one or more instructions may further cause the one or more processors to activate a new instance of the pod on the second server in response to determining that the first server is no longer available. The one or more instructions may further cause the one or more processors to identify the second server for instantiation of the new instance of the control plane from a plurality of servers by determining that a distance from the base station to the second server is less than a predefined maximum distance.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is an architectural diagram illustrating a Kubernetes® cluster.

FIG. 2 an embodiment of a cellular network system.

FIGS. 3A-G architectural diagrams illustrating the operation and management of components within a DU server system in various scenarios, according to some embodiments of the present invention.

FIGS. 4A-C are architectural diagrams illustrating the operation and management of a DU server system cluster with a single control plane, according to some embodiments of the present invention.

FIGS. 5A-C illustrate a DU server system cluster managed by an orchestrator application, according to some embodiments of the present invention.

FIGS. 6A and 6B illustrate architectural changes made to a DU server system during failure recovery orchestration, according to some embodiments of the present invention.

FIG. 7 is an architectural diagram illustrating a telecommunications system, according to some embodiments of the present invention.

FIG. 8 is a flow diagram illustrating a process for performing cluster failure management in a two server cluster when an active control plane goes down, according to some embodiments of the present invention.

FIG. 9 is a flow diagram illustrating a process for performing cluster failure management in a two server cluster when a server with an active control plane goes down, according to some embodiments of the present invention.

FIG. 10 is a flow diagram illustrating a process for performing cluster failure management in a two server cluster when an active pod goes down, according to some embodiments of the present invention.

FIG. 11 is a flow diagram illustrating a process for performing cluster failure management in a two server cluster with a single control plane using an orchestrator application, according to some embodiments of the present invention.

FIG. 12 is an architectural diagram illustrating a computing system configured for operation in a cluster failure management system, according to some embodiments of the present invention.

FIG. 13 is a flowchart illustrating a process for performing cluster failure management in a two server cluster with two control planes, according to some embodiments of the present invention.

FIG. 14 is a flowchart illustrating a process for performing cluster failure management in a two server cluster with a single control plane, according to some embodiments of the present invention.

FIG. 15 is a flowchart illustrating a process for performing cluster failure management in a two server cluster with a single control plane using an orchestrator, according to some embodiments of the present invention.

FIG. 16 is a flowchart illustrating a process for performing cluster failure management in a single server cluster with a single control plane using an orchestrator, according to some embodiments of the present invention.

Unless otherwise indicated, similar reference characters denote corresponding features consistently throughout the attached drawings.

### DETAILED DESCRIPTION

Some embodiments pertain to cluster failure management for telecommunications systems with virtualized and containerized DUs. If a pod, a control plane, or a server fails, this can be handled, and the DU can continue to function. Two or more servers may be used to provide redundancy and to insulate against hardware failure in some embodiments. Heartbeat messages between the control plane(s) and the pod(s) may be used to ensure that they are operating as intended. Such embodiments may provide a low overhead platform and control plane with resiliency against failure.

In the case of a two node cluster, an active pod and a standby pod may be used to provide redundancy. As used herein, an “active pod” is a pod that is performing DU functions for its respective cell sites and sending heartbeat messages to the active control plane. A standby pod is a pod that is not currently performing DU functions for its respective set of cell sites, but is available to do so if the corresponding active pod fails. Such embodiments may be particularly beneficial for cell sites in remote areas, where it can take significant time to reach the cell site and reliability can be improved substantially. Space available at cell sites may be constrained in cases where the DU is located nearby, so a two node (server) architecture may be beneficial due to space and cost constraints. There can be a heartbeat between two control planes, CP1 and CP2, to make sure that if the control plane goes down, the other takes over. For instance, if CP1 goes down, CP2 can declare that CP1 went down, take ownership, and become the active control plane. As used herein, the “active” control plane is the control plane that is currently managing the pods and receiving heartbeat messages therefrom. The “standby” control plane is the control plane that is available to take over for the active control plane if it fails.

Another way to accomplish this is to monitor the heartbeat messages from the active control plane externally. For instance, a non-DU computing system may manage CP1 and CP2. If this central computing system detects that CP1 has gone down, it instructs CP2 to take over as the active control plane.

One issue that should be taken into account when designing such a DU architecture is latency. Computing systems performing DU functions should be close enough to the cell site that latency is not an issue (e.g., within approximately 40 kilometers to maintain a 200 microsecond latency). If close enough, the DU computing systems could be part of a BEDC or a Local Data Center (LDC). Otherwise, the DU may be located at or near a cell site. An orchestrator computing system, if present, could be located in the network core or closer to the DU.

In some embodiments, each pod handles 9 cells. Thus, each DU can handle 18 cells in such embodiments with two pods. However, any desired number of cells may be served without deviating from the scope of the invention. In a two node architecture, a pod for the first 9 cells may be active and a pod for the second 9 cells may be on standby for one node, and vice versa for the other node.

A cell is the geographic area that is covered by a single base station in a RAN. Each cell is a frequency (spectrum) carrier. When L1 and L2 are split into two separate pods, for example, the pods handle and control the respective bands for each.

Two master nodes are typically sufficient to cover platform or application failure. During this time, network capacity is reduced, but the network continues to function. It may take hours or days to bring a failed node back up, depending on the cause of the failure and the repair that is required.

Nonetheless, in some embodiments, three or more master nodes (control planes) may be used to provide further resiliency and redundancy. In such embodiments, one node serves as the active control plane and the other nodes serve as the standby control plane(s). Thus, if the active control plane or its server go down, one or more nodes are available as control plane backups. However, adding more standby control plane nodes naturally increases cost, and the cost may outweigh the benefits.

The recommendation from Kubernetes® is to have 3 or 5 control nodes for high availability. However, network operators may choose to have only 2 nodes based on their design in some cases (e.g., to reduce cost). The use case can be different for each operator. Two nodes usually provide good resiliency for a DU.

In certain embodiments, a single active control plane is used to control multiple nodes with no standby control plane. The pods may have active and standby versions on each node. If the active pod fails on one node, the standby pod on the other node takes its place as the active pod providing DU functionality for its respective cell sites. In such embodiments, shared storage for shared persistent volumes (PV) is used, which should not exceed the maximum overhead allocated for the platform. However, such embodiments do not have control plane redundancy unless an orchestrator application monitors the control plane and attempts to instantiate the control plane on the other node in the event of failure.

Virtualized deployments may be desired for DU functions. Kubernetes®, for example, runs workloads by placing containers into pods to run on nodes. A node may be a virtual machine or a physical machine, depending on the cluster design. Each node is managed by the control plane and contains the services necessary to run the pods. Typically, multiple nodes are included in a cluster.

A pod is the smallest and simplest Kubernetes® object, representing one or more running containers on a cluster that have shared storage and network resources, as well as a specification for how to run the containers. The contents of a pod are co-located and co-scheduled, as well as run in a shared context. A pod models an application-specific “logical host”. It contains one or more application containers that are relatively tightly coupled. In non-cloud contexts, applications executed on the same physical or virtual machine are analogous to cloud applications executed on the same logical host. An example of a pod that consists of a container running the image DISH:1.1.1 is provided below.

```
apiVersion: v1
kind: Pod
metadata:
  name: DISH
spec:
  containers:
  - name: DISH
    image: DISH:1.1.1
    ports:
    - containerPort: 80
```

The control plane is the container orchestration layer that exposes the Application Programming Interface (API) and interfaces to define, deploy, and manage the lifecycle of containers. A container is a lightweight and portable executable image that contains software and all of its dependencies.

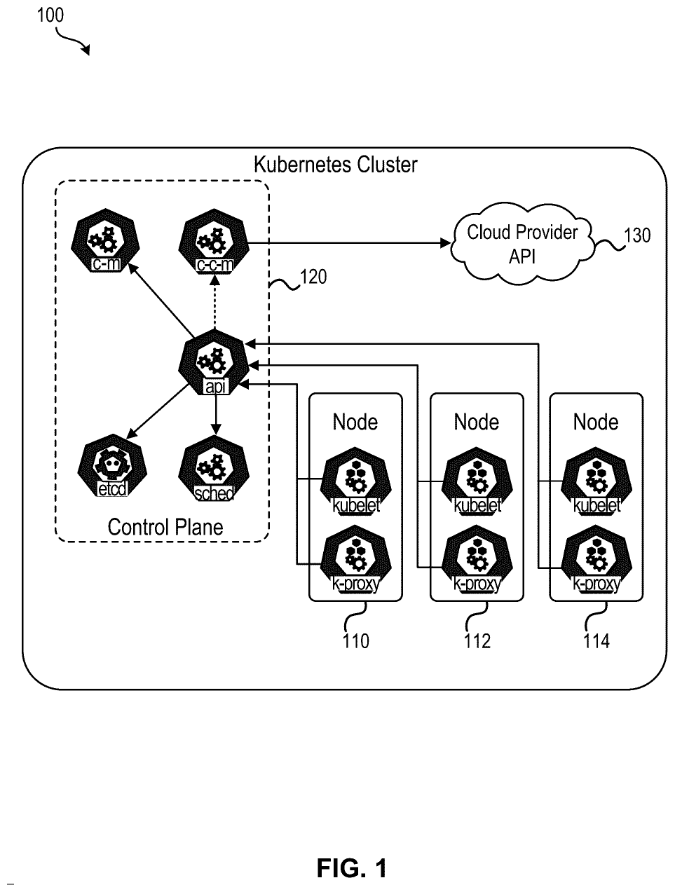

FIG. 1 is an architectural diagram illustrating a Kubernetes® cluster 100. A Kubernetes cluster consists of a set of worker machines (nodes) that run containerized applications. Each cluster has at least one worker node. In this case, Kubernetes® cluster 100 has three worker nodes 110, 112, 114.

Worker nodes 110, 112, 114 host the pods, which are the components of the application workload. A control plane 120 manages worker nodes 110, 112, 114 and the pods in cluster 100. In production environments, control plane 120 usually runs across multiple computers and a cluster usually runs multiple nodes, providing fault-tolerance and high availability.

The components of control plane 120 make global decisions about cluster 100, such as scheduling, as well as detecting and responding to cluster events (e.g., starting up a new pod when a replicas field of a deployment is unsatisfied). Components of control plane 120 can be run on any machine in cluster 100. However, for simplicity, set up scripts typically start all components of control plane 120 on the same machine, and do not run user containers on this machine.

The API server (api) of control plane 120 exposes the Kubernetes® API. The API server is the front end for control plane 120. The main implementation of a Kubernetes® API server is kube-apiserver, which is designed to scale horizontally by deploying more instances. Multiple instances of kube-apiserver can be run and traffic can be balanced between those instances. An open source distributed key-value store (etcd) is used to hold and manage the critical information that distributed systems use to keep running. This is used as the backing store for all cluster data.

The kube-scheduler (sched) of control plane 120 watches for newly created pods with no assigned node and selects a node for these new pods to run on. Factors taken into account for scheduling decisions include individual and collective resource requirements, hardware/software/policy constraints, affinity and anti-affinity specifications, data locality, inter-workload interference, and deadlines. The kube-controller-manager (c-m) is the component of control plane 120 that runs controller processes. Logically, each controller is a separate process, but to reduce complexity, they are compiled into a single binary and run in a single process. There are many different types of controllers, such as node controllers responsible for noticing and responding when nodes go down, job controllers that watch for job objects that represent one-off tasks and then create pods to run these tasks to completion, EndpointSlice controllers that populate EndpointSlice objects to provide a link between services and pods, and ServiceAccount controllers that create default ServiceAccounts for new namespaces.

The cloud-controller-manager (c-c-m) is a component of control plane 120 that embeds cloud-specific control logic. The cloud controller manager lets users link clusters into a cloud provider API 130 and separates out the components that interact with that cloud platform from components that only interact with cluster 100. The cloud-controller-manager runs controllers that are specific to the cloud provider. If Kubernetes® on a user's own premises or in a learning environment inside a personal computer (PC), the cluster does not have a cloud controller manager.

As with the kube-controller-manager, the cloud-controller-manager combines several logically independent control loops into a single binary that runs as a single process. The cloud-controller-manager can scale horizontally (i.e., run more than one copy) to improve performance or to help tolerate failures. Node controllers, route controllers, and service controllers can have cloud provider dependencies.

Node components run on each of nodes 110, 112, 114, maintaining running pods and providing the Kubernetes® runtime environment. A kubelet is an agent that runs on nodes 110, 112, 114 in cluster 100. The kubelet makes sure that containers are running in a pod. The kubelet takes a set of PodSpecs that are provided through various mechanisms and ensures that the containers described in those PodSpecs are running and healthy. The kubelet service is an agent that allows the respective worker nodes to communicate with the API server on the master node and sets up pod requirements, such as mounting volumes, starting containers, and reporting status. The kubelet does not manage containers that were not created by Kubernetes®.

The kube-proxy (k-proxy) is a network proxy that runs on each of nodes 110, 112, 114 in cluster 100. The kube-proxy maintains network rules on nodes. These network rules allow network communication to pods from network sessions inside or outside of cluster 100. The kube-proxy uses the OS packet filtering layer if there is one and it is available. Otherwise, kube-proxy forwards the traffic itself.

In some embodiments, each server in the cluster runs one or more pods, and at least one server runs an active control plane. If more than one control plane is used, another server runs a standby control plane. L2 connectivity is used to coordinate between these control planes. Using L2 connectivity between the control planes can help with carrier aggregation as well.

In embodiments with two control planes, the control planes use heartbeat messages to monitor one another. This helps to determine whether the active control plane is still functioning properly. If not (e.g., no heartbeat message is received or the heartbeat message indicates that the active control plane is experiencing an issue), the standby control plane can take over as the active control plane. The active control plane also uses heartbeat messages to monitor the pods that it manages. When a server, control plane, or pod goes down, this functionality may be implemented on another server in the cluster. Additional pods may also be spun up for other reasons, such as to handle additional traffic, apply software updates, etc. Indeed, with O-RAN embodiments, it is possible to bring pods online and take them offline as needed.

The payload exchanged in the heartbeat messages between the active control plane and the pods that it manages, as well as the payload exchanged between the active and standby control planes in two control plane embodiments, may vary depending on the requirements of the vendor. However, at a minimum, these heartbeat messages function as “keep alive” messages. Worker nodes periodically send heartbeat messages to master nodes on periodic basis. The master node typically does not need to take any action unless the heartbeat messages are no longer received. If the heartbeat messages are not received, however, the master node begins troubleshooting to try to determine the cause.

The DU may be located in an LDC or a BEDC in some embodiments. In certain embodiments, the CU may be located in the network core. In some embodiments, the backhaul may be via satellite.

Typically, m masters manage n workers. The control plane in Kubernetes® uses the master plus vertical concept, where one or more masters manage the workers. Masters help instantiate workers to deploy them in specific nodes and perform orchestration. This architecture can also help with the scalability to instantiate further pods for extra capacity and help with upgrades to upgrade workers to the latest version.

Many vendors prefer a single, shared control plane where everything is done within the cell footprint. However, some platform vendors may not be able to support the two control plane or shared control plane techniques discussed above. Accordingly, in some embodiments, if an active DU goes down, an orchestrator application running on a server at a central location (e.g., at an LDC, a BEDC, a Regional Data Center (RDC), etc.) may detect that the master control plane associated with this DU has gone down and try to instantiate the master control plane on another node that is not a standby node.

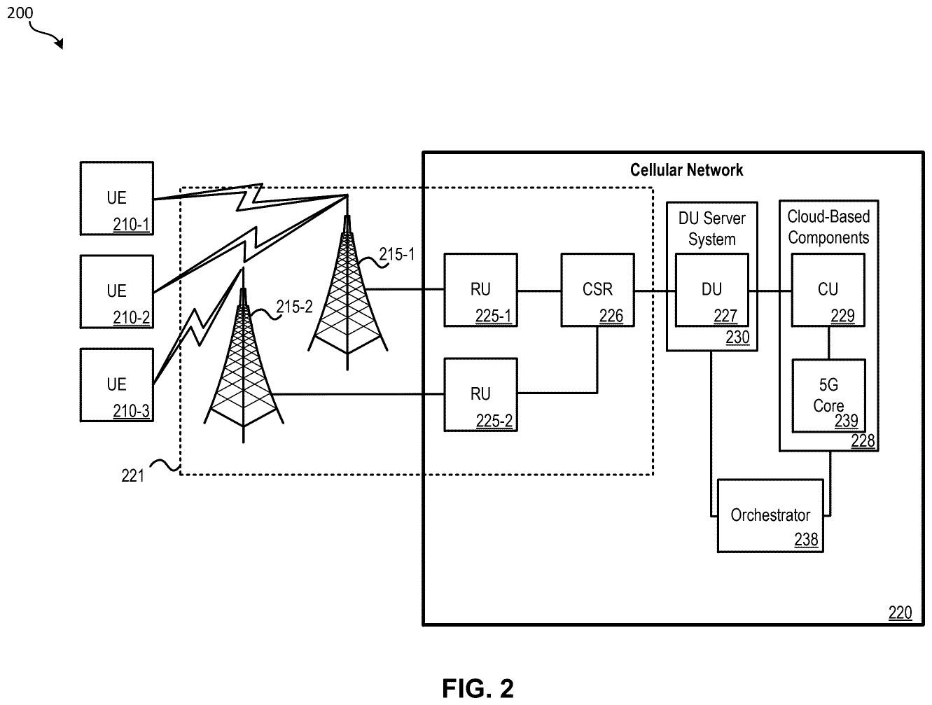

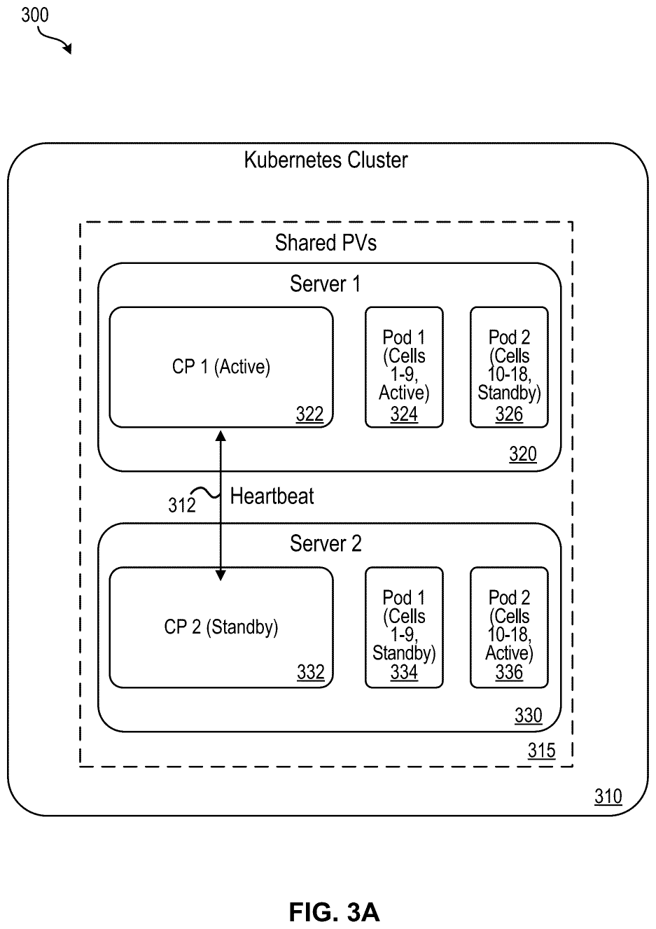

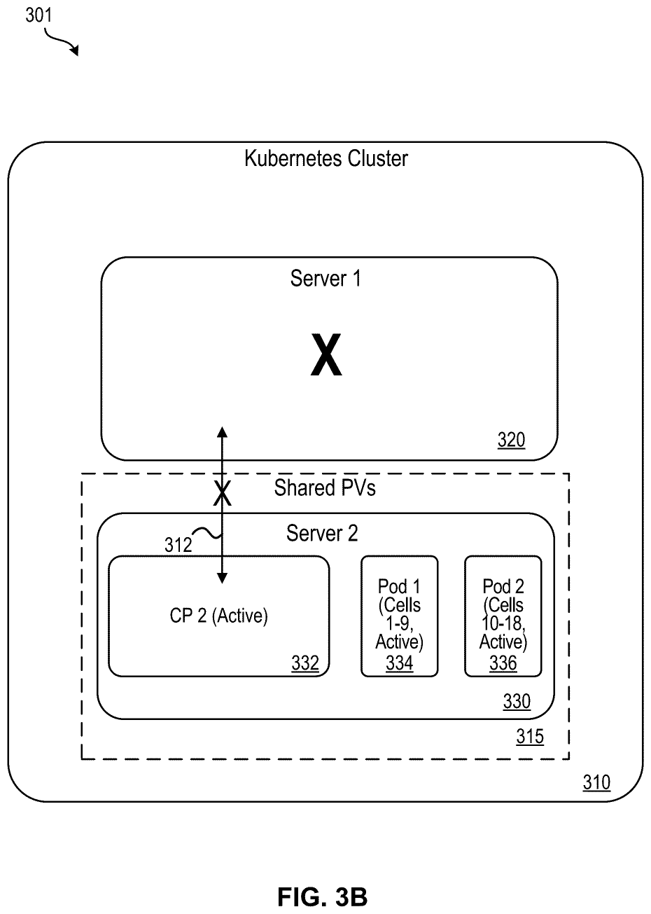

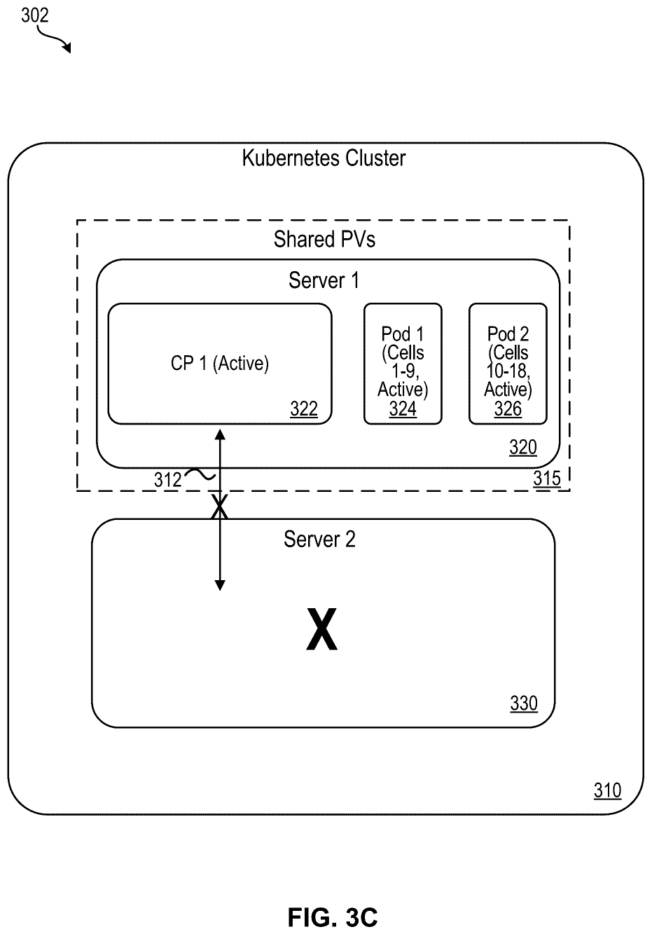

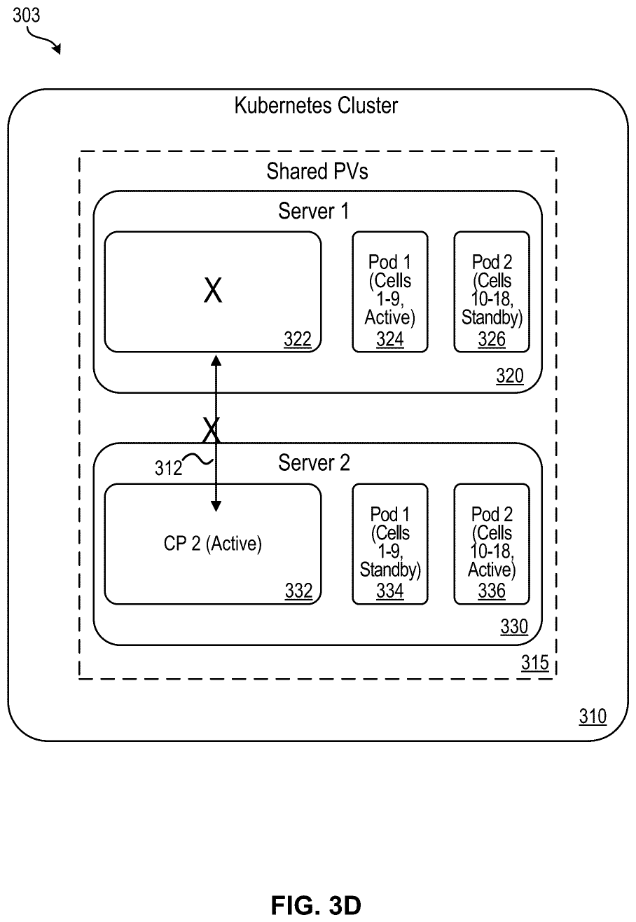

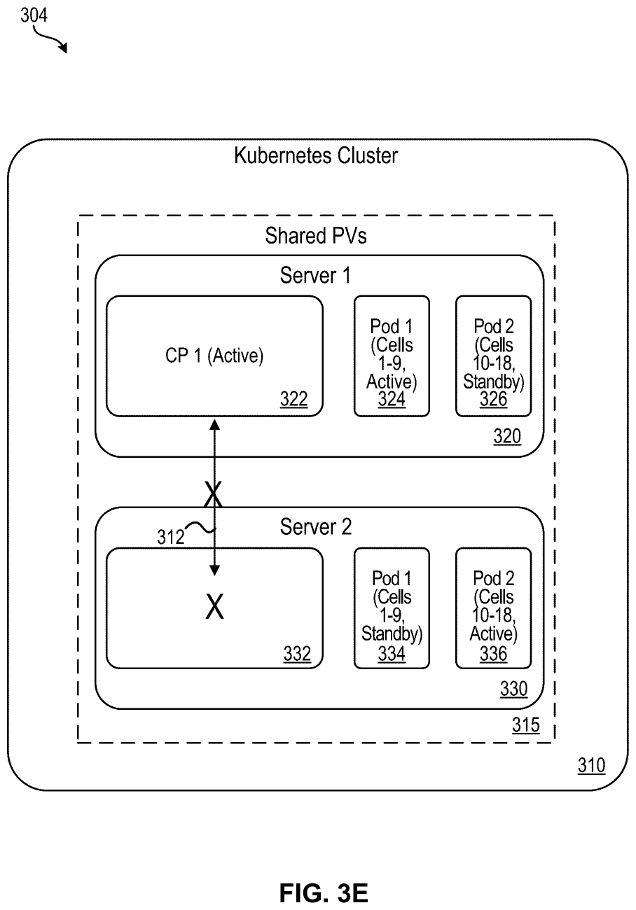

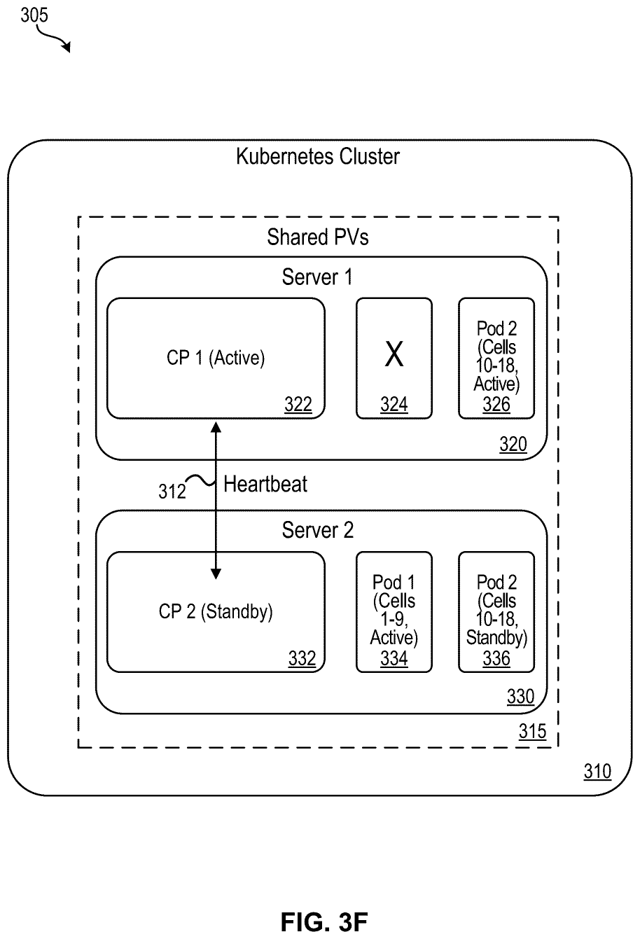

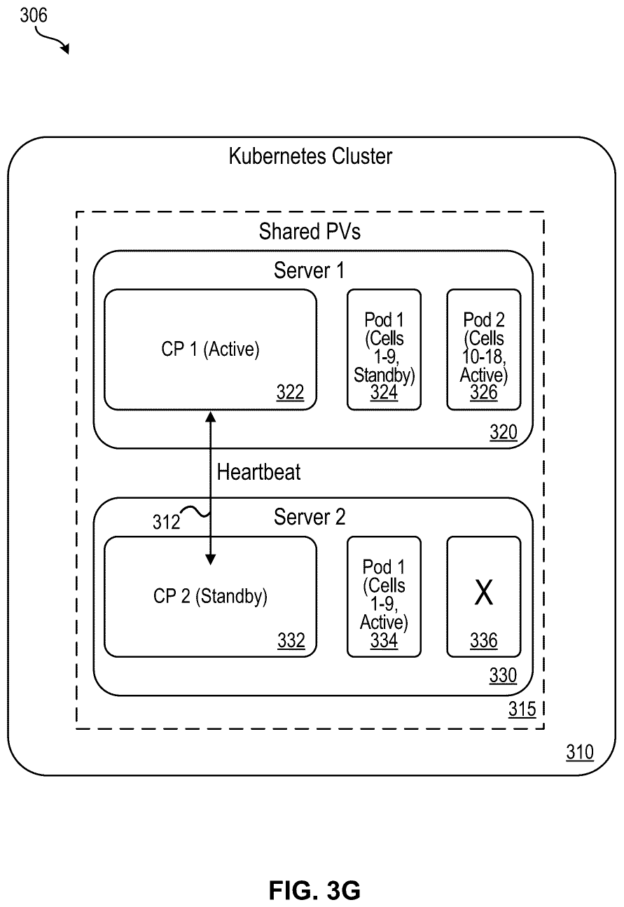

FIG. 2 illustrates an embodiment of a cellular network system 200 (“system 200”). FIG. 2 represents an embodiment of a cellular network which can accommodate the architecture of FIGS. 3A-6B. System 200 can include a 5G New Radio (NR) cellular network; other types of cellular networks, such as 6G, 7G, etc., may also be possible. System 200 can include: UE 210 (UE 210-1, UE 210-2, UE 210-3); antennas 215; cellular network 220; radio units 225 (“RUs 225”); cell site router 226 (“CSR 226”); DU 227; centralized unit 229 (“CU 229”); 5G core 239, and orchestrator 238. FIG. 2 represents a component-level view. In an open radio access network (O-RAN), because components can be implemented as specialized software executed on general-purpose hardware, except for components that need to receive and transmit Radio Frequency (RF) signals, the functionality of the various components can be shifted among different servers. For at least some components, the hardware may be maintained by a separate cloud-service provider, to accommodate where the functionality of such components is needed, or a hybrid arrangement which can use an on-premises data center and cloud computing functionality.

UE 210 can represent various types of end-user devices, such as cellular phones, smartphones, cellular modems, cellular-enabled computerized devices, sensor devices, gaming devices, access points (APs), any computerized device capable of communicating via a cellular network, Internet of Things (IoT), etc. Generally, UE can represent any type of device that has an incorporated 5G interface, such as a 5G modem. Examples can include sensor devices, Internet of Things (IoT) devices, manufacturing robots, unmanned aerial (or land-based) vehicles, network-connected vehicles, etc. Depending on the location of individual UEs, UE 210 may use RF to communicate with various base stations (BSs) of cellular network 220, such as BS 221. BS 221 can include: antennas 215, RUs 225, and CSR 226. Antennas 215 may be mounted to a physical structure, such as a dedicated cellular tower, a building, a water tower, or any other man-made or natural structure to which one or more antennas can reasonably be mounted to provide cellular coverage to a geographic area.

Real-world implementations of system 200 can include many (e.g., thousands) of BSs and many CUs and 5G core 239. Antennas 215 may allow RUs 225 to communicate wirelessly with UEs 210. RUs 225 can represent an edge of cellular network 220 where data is transitioned to RF for wireless communication. The radio access technology (RAT) used by RU 225 may be 5G New Radio (NR), or some other RAT. The remainder of cellular network 220 may be based on an exclusive 5G architecture, a hybrid 4G/5G architecture, a 4G architecture, or some other cellular network architecture.

One or more RUs, such as RUs 225, may communicate with DU 227 via one or more routers, such as CSR 226. As an example, at a possible cell site, three RUs may be present, each connected with the same DU. A single DU may further be connected to RUs at multiple cell sites or BSs. Different RUs may be present for different portions of the spectrum and/or different cells provided by a BS. For instance, a first RU may operate on the spectrum in the citizens broadcast radio service (CBRS) band while a second RU may operate on a separate portion of the spectrum, such as, for example, band 71. In some embodiments, an RU can also operate on three bands. One or more DUs, such as DU 227, may communicate with CU 229. Collectively, an RU, DU, and CU create a gNodeB, which serves as the radio access network (RAN) of cellular network 220. DU 227 and CU 229 can communicate with 5G core 239. The specific architecture of cellular network 220 can vary by embodiment. Edge cloud server systems outside of cellular network 220 may communicate, either directly, via the Internet, or via some other network, with components of cellular network 220. For example, DU 227 may be able to communicate with an edge cloud server system without routing data through CU 229 or 5G core 239. Other DUs may or may not have this capability.

While FIG. 2 illustrates various components of cellular network 220, other embodiments of cellular network 220 can vary the arrangement, communication paths, and specific components of cellular network 220. While RUs 225 may include specialized radio access componentry to enable wireless communication with UE 210, other components of cellular network 220 may be implemented using either specialized hardware, specialized firmware, and/or specialized software executed on a general-purpose server system. In an O-RAN arrangement, specialized software on general-purpose hardware may be used to perform the functions of components such as DU 227, CU 229, and 5G core 239. As such, functionality of components such as DUs and CUs can be co-located or distributed across disparate physical server systems. For example, certain components of 5G core 239 may be co-located with components of CU 229.

As illustrated, DU 227 may be executed by DU server system 230. As described further herein, DU server system 230 may include one or more physical and/or virtual machines configured to execute some or all of the functions of DU 227. For example, DU server system 230 may include a cluster of one or more physical servers. Specialized software that performs the logical functions of one or more DUs, such as DU 227, may be executed directly by the operating system of the one or more physical servers. Additionally, or alternatively, a cluster of one or more virtual machines may be instantiated across the cluster of one or more physical servers. The specialized software that performs the logical functions of the one or more DUs may then be installed within, and executed by, the virtual machines.

In a possible O-RAN implementation, DU 227, CU 229, 5G core 239, and/or orchestrator 238 can be implemented virtually as software being executed by general-purpose computing equipment, such as in a data center, as detailed herein. Therefore, depending on needs, the functionality of a DU, CU, and/or 5G core may be implemented locally to each other and/or specific functions of any given component can be performed by physically separated server systems (e.g., at different server farms). For example, the physical machines of DU server system 230 may be located at or near the one or more BSs for which they are intended to support, such as BS 221. In some embodiments, the distance is selected to ensure that the transmission time between the DU server system and any of the BSs for which it is intended to provide DU functionalities meets minimum latency requirements. As another example, some functions of a CU may be located at a same server facility as DU server system 230, while other functions are executed at a separate server system or on a public or private cloud computing system. In the illustrated embodiment of system 200, cloud-based cellular network components 228 include CU 229 and 5G core 239. Such cloud-based cellular network components 228 may be executed as specialized software executed by underlying general-purpose computer servers. Cloud-based cellular network components 228 may be executed on a third-party cloud-based computing platform or a cloud-based computing platform operated by the same entity that operates the RAN. A cloud-based computing platform may have the ability to devote additional hardware resources to cloud-based cellular network components 228 or implement additional instances of such components when requested.

Kubernetes, Docker®, or a similar container orchestration platform, can be used to create and destroy the logical DU, CU or 5G core units and subunits as needed for the cellular network 220 to function properly. Kubernetes allows for container deployment, scaling, and management. As an example, if cellular traffic increases substantially in a region, an additional logical CU or components of a CU may be deployed in a data center near where the traffic is occurring without any new hardware being deployed. Rather, processing and storage capabilities of the data center would be devoted to the needed functions. When the need for the logical CU or subcomponents of the CU no longer exists, Kubernetes can allow for removal of the logical CU. In addition to scalability, Kubernetes can also be used for failure management of various components of cellular network 220, as described further herein. Kubernetes can also be used to control the flow of data (e.g., messages) and inject a flow of data to various components. This arrangement can allow for the modification of nominal behavior of various layers.

The deployment, scaling, and management of such virtualized components can be managed by orchestrator 238. Orchestrator 238 can represent various software processes executed by underlying computer hardware. Orchestrator 238 can monitor cellular network 220 and determine the amount and location at which cellular network functions should be deployed to meet or attempt to meet service level agreements (SLAs) across slices of the cellular network. Additionally, or alternatively, Orchestrator 238 can monitor one or more DU server systems, such as DU server system 230, and provision physical and/or virtual resources in response to increased demands or failing components.

Orchestrator 238 can allow for the instantiation of new components of cellular network 220. As an example, to instantiate a new core function, a backup function, or the like, orchestrator 238 can perform a pipeline of calling the core function code from a software repository incorporated as part of, or separate from, cellular network 220; pulling corresponding configuration files (e.g., helm charts); creating Kubernetes nodes/pods; loading the related core function containers; configuring the core function; and activating other support functions (e.g., Prometheus, instances/connections to test tools).

FIGS. 3A-3G are architectural diagrams illustrating the operation and management of components within a DU server system in various scenarios. As described above, a DU server system, such as DU server system 230, may include a cluster of one or more physical and/or virtual machines or servers, such as cluster 310. In some embodiments, a container orchestration platform, such as Kubernetes, may manage and coordinate the resources of cluster 310. As illustrated, cluster 310 includes first server 320 and second server 330. As described above, first server 320 and/or second server 330 may include a combination of physical and/or virtual machines. For example, first server 320 and second server 330 may be virtual machines executing on one or more physical machines. Additionally, or alternatively, first server 320 and/or second server 330 may be individual physical machines. As further illustrated, cluster 310 may include one or more persistent volumes (PVs), such as PV 315, shared by the resources of cluster 310, such as first server 320 and second server 330. PV 315 may include storage that is physically and/or logically external to first server 320 and second server 330. As such, data in PV 315 may remain accessible independent of the state of either of first server 320 or second server 330.

Cluster 310 may include one or more instances of a control plane (CP), such as first CP 322 and second CP 332. The CP is responsible for managing and orchestrating the resources of a cluster. The one or more instances of the CP may be installed on separate nodes during the initial provisioning and/or setup of cluster 310. For example, first CP 322 may be installed on first server 320 and second CP 332 may be installed on second server 330. Additionally, or alternatively, instances of the CP may be installed on-the-fly in response to various stimuli, such as the failure of an existing instance, the availability of a new node, or the like.

Each instance of the CP may share common and/or similar configurations that allow them to maintain a consistent state and functionality of the cluster, including the various working resources. The working resources in a cluster may include separate nodes or machines (e.g., physical and/or virtual) from the node, or nodes, executing the CP. Additionally, or alternatively, working resources, such as pods, may be installed on the same node as a CP.

As illustrated, two or more instances of the CP may be installed and running in a high availability cluster, with only one of the instances actively managing and orchestrating the resources of the cluster. For example, first CP 322 may initially be the active instance within cluster 310. The remaining instances, such as second CP 332 may be running in standby. Standby instances may monitor the health and status of the active instance, and vice versa. For example, as the active instance, first CP may send a heartbeat 312 or status updates to the standby instances, such as second CP 332, to indicate that it is still functioning properly. Second CP 332 may also monitor, and/or receive updates on, the state and functionality of the various resources within cluster 310.

Cluster 310 may include one or more pods, such as first pod 324 and second pod 336. As described above, each pod may include one or more containers that are tightly coupled and share certain resources, such as networking namespace and storage volumes. The containers within each pod may work together to provide a cohesive set of functionalities. For example, within cluster 310, first pod 324 may provide DU functionalities for a first set of RUs within a cellular network, while second pod 336 may provide similar DU functionalities for a second set of RUs within the cellular network. As described above, each set of RUs may be located at a same base station, or at different base stations in close geographic proximity with each other. As further described above, each RU may support a respective cell of the cellular network. As such, each pod may act as the DU for multiple cells within the cellular network. In some embodiments, each pod supports up to nine cells.

First pod 324 and second pod 336 may be deployed as instances of a preconfigured pod object during the initial provisioning and/or setup of cluster 310. A preconfigured pod object may include definitions for the one or more containers and their associated resources, such as volumes, network configurations, and environment variables, needed to provide the DU functionalities for a specific set of RUs. Once installed and executing on their respective nodes, each instance may be considered as an active pod, or an active instance of a pod.

As further illustrated, cluster 310 may include multiple instances, or replicas, of a pod for redundancy, load balancing, and fault tolerance. For example, first pod replica 334 may be a replica of first pod 324 and second pod replica 326 may be a replica of second pod 336. Replicas may be deployed during the initial setup of cluster 310 and/or deployed dynamically only after an active instance of a pod fails. In some embodiments, replicas deployed during the initial setup are actively running and serving requests concurrently. Additionally, or alternatively, such replicas may be running in a standby state, waiting to receive the workload of the active instance in the event that the active instance fails or is no longer available (e.g., in the case of a node failure).

In scenario 300 of FIG. 3A, cluster 310 is operating normally. However, in scenario 301 of FIG. 3B, first server 320 has become unavailable. Second CP 332 may determine that first server 320 and/or first CP 322 have failed from the absence of heartbeat 312 from first server 320. This may be determined based on a predetermined number of heartbeat messages being missed (e.g., two messages, five messages, ten messages, etc.), heartbeat messages not being received for a certain period of time (e.g., one second, ten seconds, one minute, etc.), etc. In some embodiments, second CP 332 may send a message to first CP 322 attempting to reestablish the heartbeat messages. If failure is determined by second CP 332, second CP 332 may put itself in active mode and assume the functions previously performed by first CP 322. In this embodiment, second CP 332 also activates first pod replica 334 to perform the functions previously performed by first pod 324. In embodiments where only active pods are running, second CP 332 may deploy and activate first pod replica 334. It should be noted that while two pods are used by way of example in the figures, any desired number of pods may be used without deviating from the scope of the invention, so long as the underlying hardware is capable of running them.

In scenario 302 of FIG. 3C, a server failure has occurred—in this case, second server 330. This may be detected by first CP 322 not receiving heartbeat 312 from second CP 332. In response, first CP 322 may deploy and/or activate second pod replica 326 to perform the functions previously performed by second pod 336.

As described above, first CP 322 and second CP 332 may sync up with each other, or otherwise monitor the status of cluster 310, so each knows which pods are running. In other words, in addition to heartbeat 312, there may also be a synchronization between first CP 322 and second CP 332 regarding what pods are being managed. When a new pod is added or a pod is removed, first CP 322 may share this information with second CP 332. Transactions that change the configuration of cluster 310 are shared between the instances of the control plane.

In scenario 303 of FIG. 3D, first CP 322 has become unavailable while first pod 324 continues to execute on first server 320. Similar to scenario 301, second CP 332 may detect the absence of heartbeat 312 from first CP 322 and determine that first CP 322 has failed. In response, second CP 332 may become the active instance within cluster 310, determine whether first pod 324 is still active, and begin managing each of the pod instances.

In scenario 304 of FIG. 3E, second CP 332 has become unavailable while second pod 336 continues to execute on second server 330. First CP 322 may detect this scenario from the absence of heartbeat 312 from second CP 332. Since first CP 322 is already the active instance of the control plane, no changes are needed to first CP 322 or any of the pod instances. However, in some embodiments, it may be possible to recover second CP 332. For instance, a new instance of second CP 332 may be instantiated on second server 330 if resources permit, a server restart will fix resource limitations, etc.

In scenario 305 of FIG. 3F, first pod 324 has failed. For instance, first pod 324 may have crashed, first server 320 may have insufficient resources to continue running first pod 324, etc. This may be detected by first CP 322 due to not receiving a heartbeat message from first pod 324 for a period of time, due to failure information in the heartbeat message, etc. In response, first CP 322 may deploy, or otherwise activate, first pod replica 334 on second server 330 to take over the functionalities previously being provided by first pod 324. To balance the load between first server 320 and second server 330, and/or to provide better fault tolerance, first CP 322 may also deactivate second pod 336 on second server 330 and deploy, or otherwise activate, second pod replica 326 on first server 320. In some embodiments, first CP 322 attempt to recover first pod 324 on first server 320 before activating/deploying first pod replica 334 on second server 330.

In scenario 306 of FIG. 3G, second pod 336 of second server 330 has gone down. In response, first CP 322 may deploy and/or activate second pod replica 326 on first server 320 to provide the functionalities previously provided by second pod 336. First CP 322 may also deactivate first pod 324 and activate first pod replica 334 on second server 330. In some embodiments, first CP 322 may attempt to recover second pod 336 on second server 330 before deploying and/or activating second pod replica 326 on first server 320.

Various policies may be implemented to manage the control planes and pods in some embodiments. For instance, policies may dictate which pods may be on which servers, whether there are shared storage requirements, etc. In some embodiments, the active control plane may try to recover a pod on the same node on which it was initially running before bringing up the pod on another node.

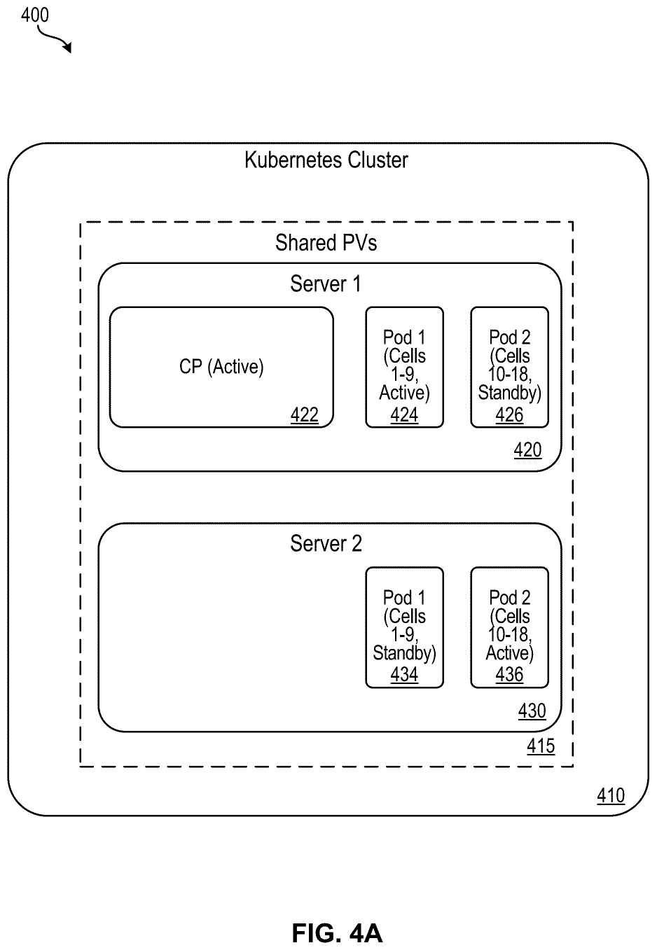

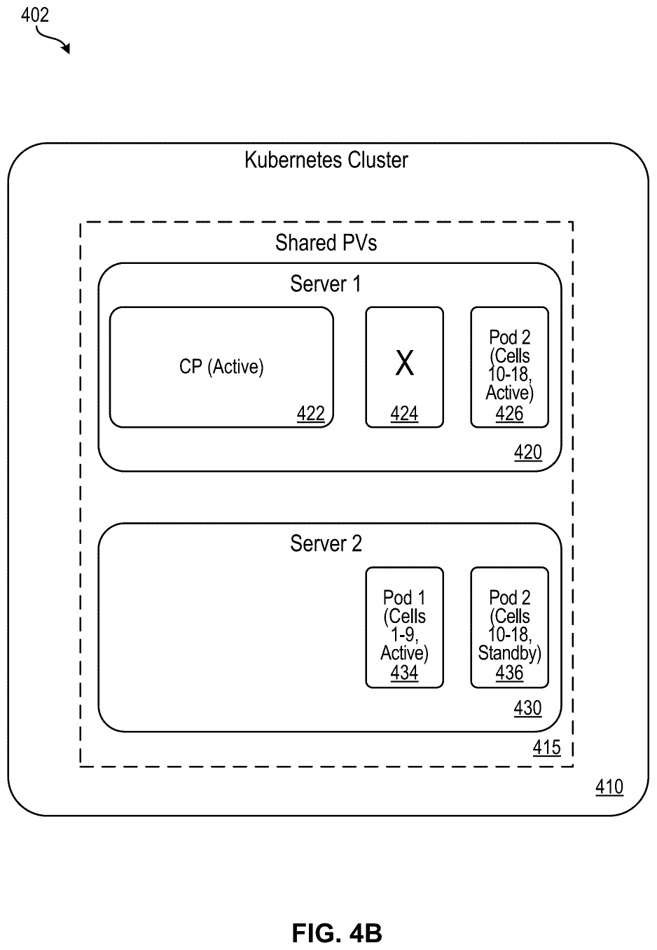

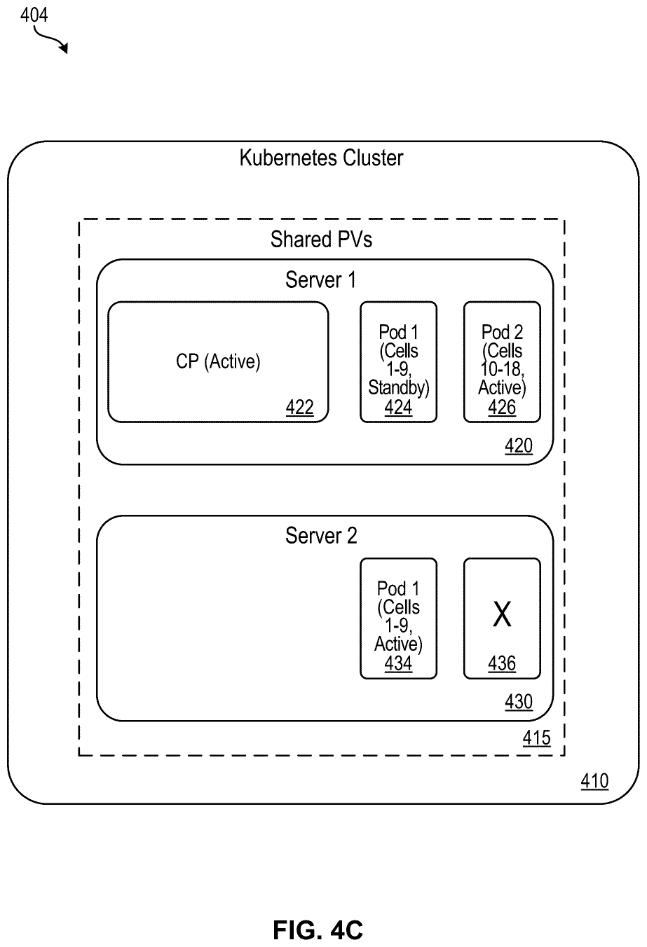

FIGS. 4A-4C are architectural diagrams illustrating the operation and management of a cluster 410 with a single control plane. As described above in relation to cluster 310, cluster 410 may be a part of a DU server system, such as DU server system 230. Cluster 410 may include similar components as cluster 310, such as first server 420, second server 430, and a shared PV 415. However, compared with cluster 310, cluster 410 may include a single CP, such as CP 422. CP 422 may be installed on first server 420 to orchestrate and manage one or more pods executing on first server 420 and/or second server 430, such as first pod 424, first pod replica 434, second pod 436, and second pod replica 426. In scenario 400 of FIG. 4A, cluster 410 is running normally, with CP 422 managing execution of first pod 424 on first server 420 and second pod 436 on second server 430. As further described above, first pod 424 and second pod 436 may each be configured to provide DU functionalities for respective sets of RUs at one or more base stations within a cellular network.

In scenario 402 of FIG. 4B, pod 424 has failed. CP 422 may detect the failure from an absence of a heartbeat message, for example. For instance, the heartbeat message may not be received for a period of time, the heartbeat message may indicate that a failure has occurred, etc. In response, CP 422 may deploy and/or activate first pod replica 434 on second server 430 to provide the DU functionalities previously provided by first pod 424. CP 422 may also deactivate second pod 436 on second server 430 and deploy and/or activate second pod replica 426 on first server to balance the workload between first server 420 and second server 430. In some embodiments, CP 422 deactivates active pods and deploys and/or activates pod replicas in response to determining that a failed pod cannot be reactivated. For example, before deploying and/or activating first pod replica 434 on second server 430, CP 422 may initially try to reactivate first pod and/or deploy a new instance of first pod on first server 420.

In scenario 404 of FIG. 4C, second pod 436 has failed. As was the case in scenario 402, CP 422 may deploy and/or activate second pod replica 426 on first server 420 to provide the DU functionalities previously provided by second pod 436. CP 422 may also deactivate first pod 424 on first server 420 and deploy and/or activate first pod replica 434 on second server 430 to balance the workload between first server 420 and second server 430.

It should be noted that since there is a single CP, if CP 422 fails, visibility into, and/or control over, the active and/or standby pods in cluster 410 may be lost. Accordingly, an orchestrator application may function as an intelligence layer that is used to try to recover the control plane if it goes down (e.g., by instructing first server 420 or second server 430 to try to instantiate an instance of the control plane). The orchestrator application may try to understand the cause of the failure. For instance, if the whole server that ran the control plane went down, the orchestrator application may try to instantiate the control plane on the other server if resources permit. If the server that ran the control plane is still running, the orchestrator application may try to instantiate a new instance of the control plane on that server, and then try on the second server if this fails.

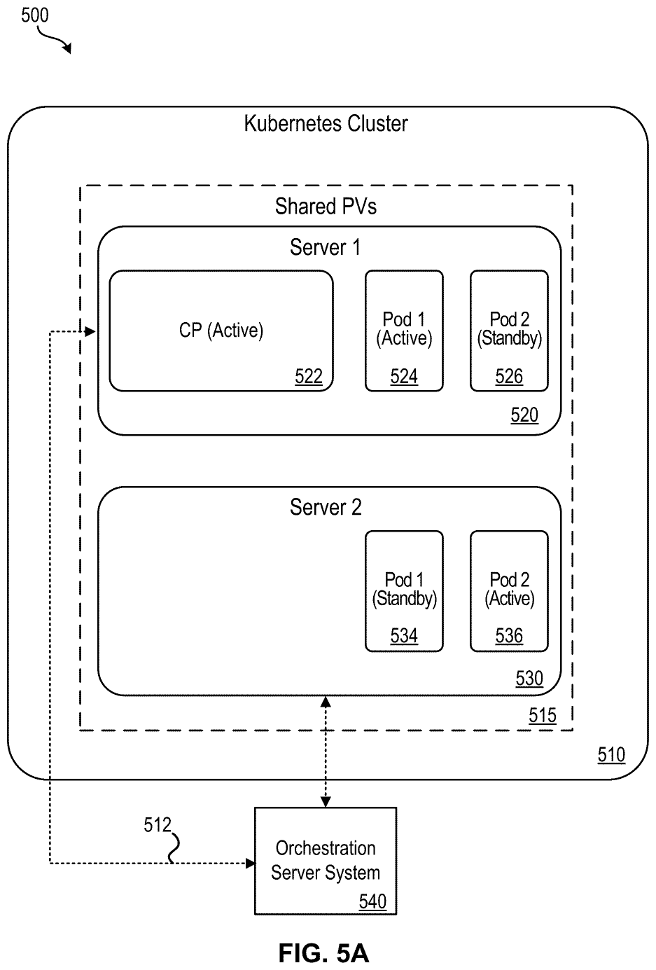

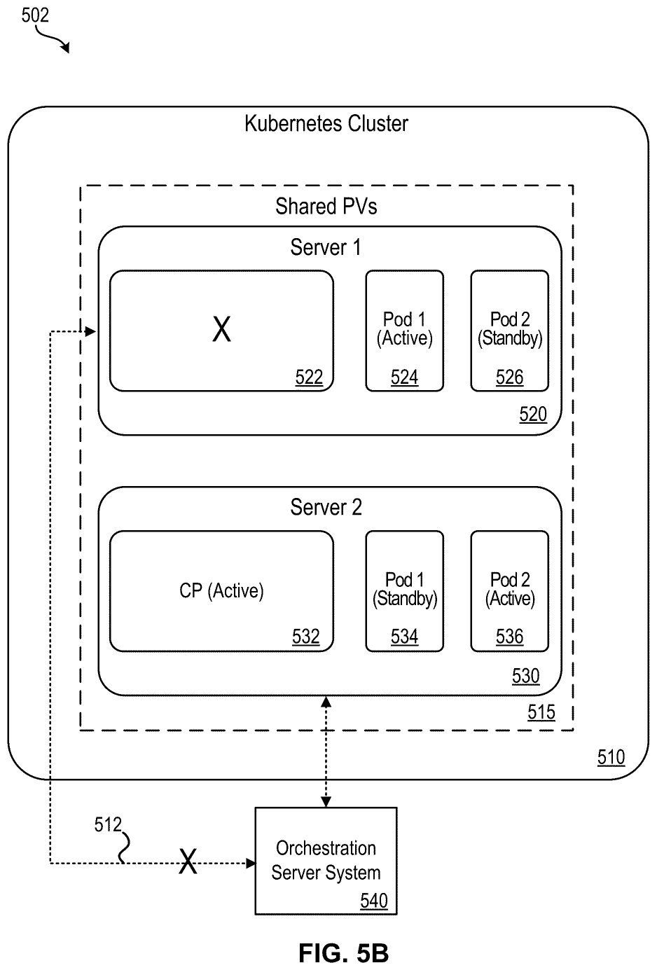

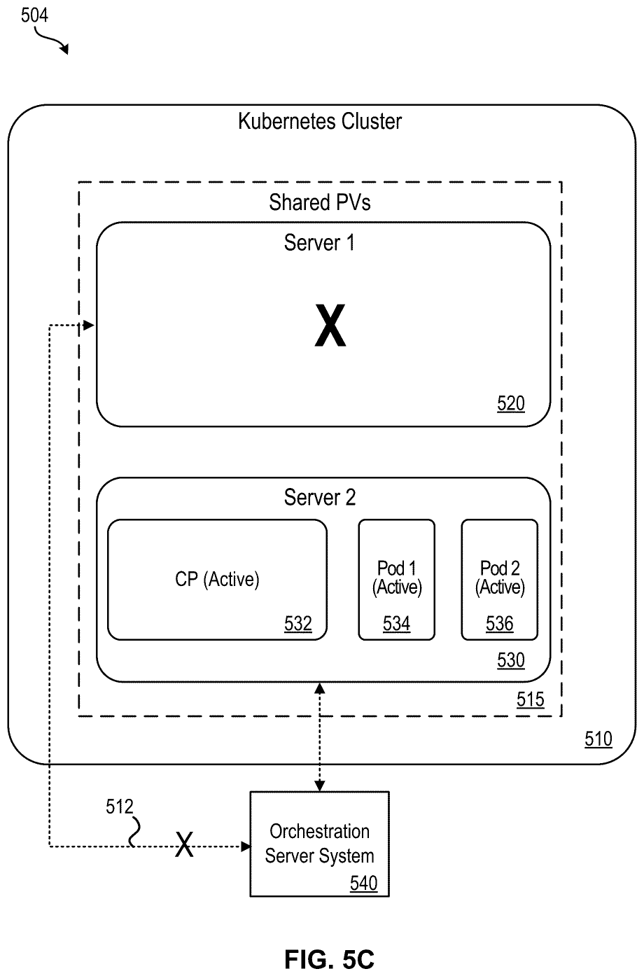

FIGS. 5A-5C illustrate a cluster 510 managed by an orchestrator application, according embodiments of the present invention. As described above in relation to cluster 310 and cluster 410, cluster 510 may be a part of a DU server system, such as DU server system 230. Cluster 510 may include similar components as cluster 310 and/or cluster 410, such as first server 520, second server 530, and a shared PV 515. Cluster 510 may include a single CP, such as CP 522. CP 522 may be installed on first server 520 to orchestrate and manage one or more pods executing on first server 520 and/or second server 530, such as first pod 524, first pod replica 534, second pod 536, and second pod replica 526. As further illustrated, one or more components of cluster 510 may be communicatively connected to orchestration server system 540.

Orchestration server system 540 may include one or more physical and/or virtual machines executing one or more orchestration applications. Physical servers of orchestration server system 540 may be located at a same facility as the physical servers of cluster 510. Additionally, or alternatively, orchestration server system 540 may include private and/or public cloud computing infrastructure connected via one or more networks with cluster 510. Orchestration applications executing on orchestration server system 540 may monitor, manage, and orchestrate the execution of one or more components of cluster 510. For example, one or more orchestration applications running on orchestration server system 540 may monitor the status and availability of first server 520 and second server 530. As another example, the one or more orchestration applications may transmit and/or receive heartbeat messages 512 to/from CP 522 to monitor the status and/or availability of CP 522.

In some embodiments, an orchestration application manages the execution of CP 522 within cluster 510. For example, and as described further below, orchestration applications may reinstantiate and/or reinstall CP 522 on first server 520 in response to determining that CP 522 is no longer executing on first server 520. Additionally, or alternatively, orchestration applications may create a new instance of CP 522 on second server 530 in response to determining that CP 522 is no longer executing on first server 520. In scenario 500 of FIG. 5A, cluster 510 is operating normally with CP 522 running on first server 520 and managing the executions of first pod 524 and second pod 536 on first server 520 and second server 530 respectively.

In scenario 502 of FIG. 5B, control plane 522 has failed and/or is no longer available. An orchestrator application running on orchestration server system 540 may detect that CP 522 is no longer running on first server 520 from an absence of heartbeat messages 512 from CP 522, and/or one or more messages including an error condition. In response, the orchestrator application may attempt to restart, reinstantiate, or otherwise reinstall CP 522 on first server 520. Additionally, or alternatively, an orchestration application may determine that CP 522 is no longer available, and cannot be restarted on first server 520, in response to determining that first server 520 is no longer available. To keep cluster 510 running, an orchestrator application running on orchestration server system 540 may instantiate new CP 532 on second server 530 as a new instance of CP 522. Once instantiated, new CP 532 may take over management of the pods in cluster 510. Additionally, or alternatively, the orchestrator application may configure new CP 532, and/or the one or more active pods, to begin working together under the management and orchestration of new CP 532.

In scenario 504 of FIG. 5C, first server 520 has failed and/or is no longer available. As described above, an orchestrator application running on orchestration server system 540 may detect this from an absence of heartbeat messages 512 from CP 522 and/or first server 520. Additionally, or alternatively, the orchestrator application may determine that first server 520 has failed in response to trying to establish contact with first server 520 but failing to do so. In response to determining that first server 520 has failed, or is otherwise no longer available, the orchestrator application may instantiate new CP 532 on second server 530 as a new instance of CP 522. New CP 532, and/or the orchestrator application, may then install and/or activate first pod replica 534 on second server 530 to begin providing the functionalities previously provided by first pod 524 on first server.

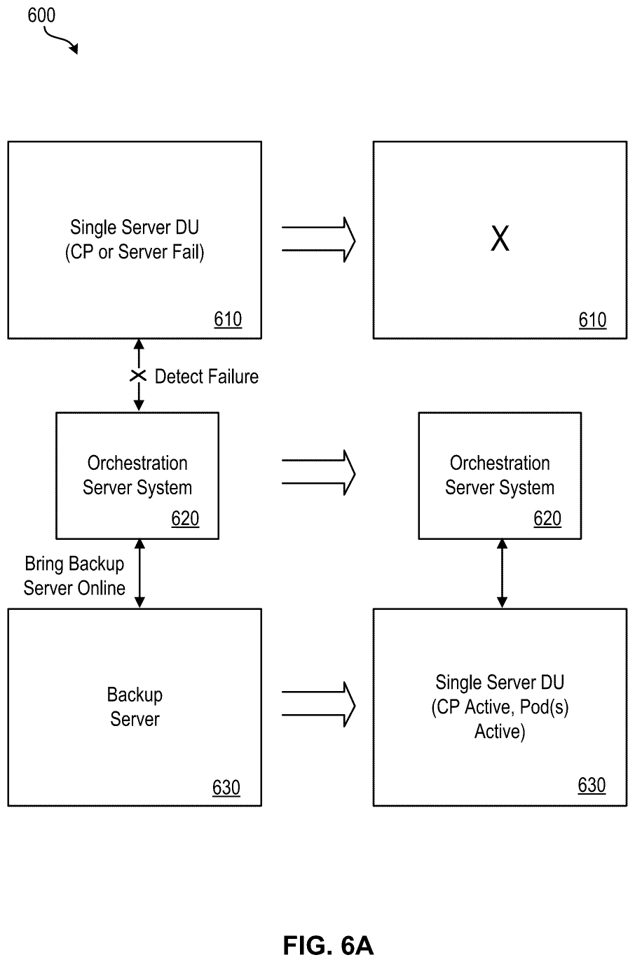

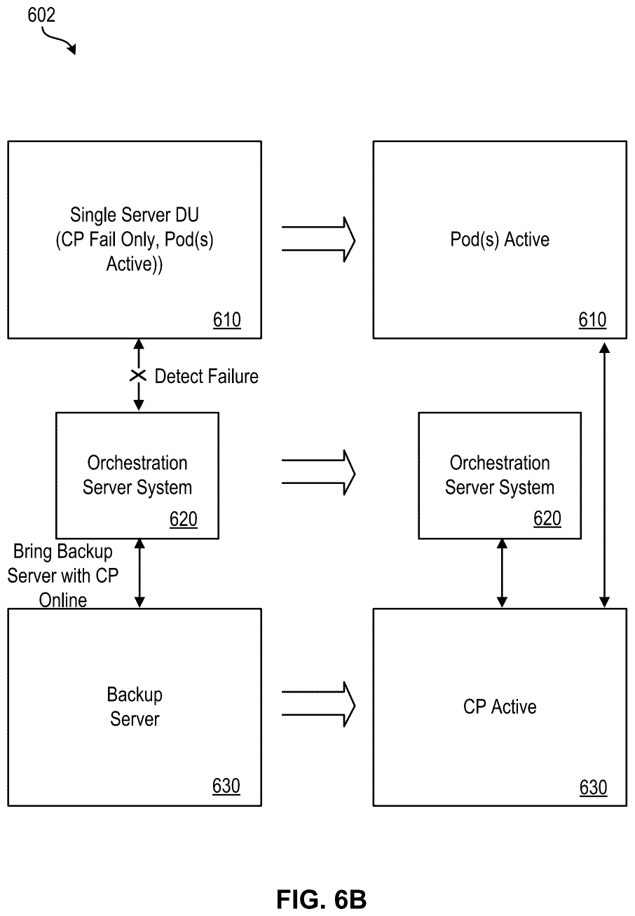

FIGS. 6A and 6B illustrate architectural changes made to a DU server system during failure recovery orchestration. As described above, some DU server systems, such as DU server system 230, may include a single physical and/or virtual machine, such as DU server 610. Using a single machine may allow the cellular network to use fewer computing resources while providing the same, or similar, support for RUs at one or more base stations. As described above in reference to cluster 310, cluster 410, and/or cluster 510, DU server 610 may represent a cluster with a single node, or machine. As further described above, DU server 610 may execute a CP to orchestrate and manage the execution of one or more pods on DU server 610. Each pod may include one or more containers that configures the pod to provide DU functionalities and services to one or more RUs.

As further illustrated, orchestration server system 620 may be communicatively connected to DU server 610 and backup server 630. Orchestration server system 620 may be the same, or function in a similar manner, as orchestration server system 540. For example, orchestration server system 620 may include one or more physical and/or virtual machines executing one or more orchestration applications that manage one or more servers, DU server systems, or the like. In some embodiments, backup server 630 is a separate physical from DU server 610 located at a same or different facility. Additionally, or alternatively, backup server 630 may be a separate virtual machine executing on a same machine as DU server 610.

In scenario 600 of FIG. 6A, DU server 610 has failed and/or the CP executing on DU server 610 has failed and there may be insufficient resources to recover the CP on DU server 610. As mentioned above, some platform vendors may not be able to support two CPs or shared control plane techniques discussed herein. An orchestrator application running on orchestration server system 620 may determine that DU server 610, and/or the CP executing on DU server 610, have failed. For example, the orchestrator application may determine that DU server 610 and/or the CP have failed in response to determining that heartbeat messages from DU server 610 and/or the CP have not been received for a predefined amount of time. Additionally, or alternatively, the orchestrator application may determine that DU server 610 has failed in response to determining that DU server 610 is no longer reachable.

In response to determining that the CP is no longer available on DU server 610 or has failed, the orchestrator application running on orchestration server system 620 may attempt to recover the CP on DU server 610. If this is not successful (e.g., DU server 610 is down or there are insufficient resources on DU server 610 for the control plane), the orchestrator application may bring backup server 630 online to function in the place of the failed DU server. As described herein, bringing backup server 630 online may include instantiating a new virtual machine instance of DU server 610 from the same or similar configurations used to deploy DU server 610. Additionally, or alternatively, bringing backup server 630 online may include deploying and/or activating new instances of the CP and/or one or more replicas of the pods originally deployed on DU server 610. In some embodiments, the backup server 630, and/or the new instances of the CP and one or more pods, are deployed on the same physical machine as DU server 610. Additionally or alternatively, backup server 630 may be, or be installed on, a separate physical machine.

In scenario 600, backup server 630 and DU server 610 may be in the same location. However, it is possible that, by bringing backup server 630 online, the DU functionalities may be provided from a different location. For instance, by having a backup server take over for the failed DU, this may move the DU from a cell site to an LDC, a BEDC, etc. In embodiments where DU server 610 and backup server 630 are, or are installed on, separate physical machines, the orchestration application may select backup server 630 from multiple backup servers based on the location of the RUs and/or base stations being supported by DU server 610. For example, an orchestrator application may bring backup server 630 online to replace DU server 610 in response to determining that backup server 630 is the closest, or next closest, backup server to the base station previously being supported by DU server 610. As another example, the orchestrator application may select backup server 630 from a plurality of backup servers in response to determining that backup server 630 is within a predefined geographical distance from the one or more base stations previously supported by DU server 610. In some embodiments, the predefined geographical distance is selected to meet latency requirements between the backup server and the base station or cell sites that will be supported. For example, the predefined geographical distance may be approximately 40 kilometers to maintain a 200 microsecond fronthaul latency between the backup DU server and the RUs at the base station.

In scenario 602 of FIG. 6B, only the CP of DU server 610 has failed. An orchestrator application running on orchestration server system 620 may determine that the CP alone has failed in response to determining that communication between DU server 610 and orchestration server system 620 is still functioning, but that the CP is no longer responsive and/or transmitting heartbeat messages. In response, the orchestrator application may try to recover the CP on DU server 610. As described herein, recovering the CP may include trying to restart the one or more services on DU server 610, deploying a new instance of the CP on DU server 610, or the like. In response to determining that the CP cannot be recovered on DU server 610, the orchestrator application may bring backup server 630 online, as described above in relation to scenario 600. For example, the orchestrator application may deploy a new instance of the CP on a new or existing physical or virtual machine. In this case, because DU server 610 is still functional, the pods previously managed by the CP on DU server 610 may be unaffected by the CP failure. As such, the orchestrator application may configure the new instance of the CP running on backup server 630 to manage the existing active pods executing on DU server 610 rather than deploying and/or activating replica pods on backup server 630. In embodiments where backup server 630 and DU server 610 are in different geographic locations, backup server 630 may be selected to run the CP despite backup server 630 being further from the base station than the predefined maximum distance because the execution of the active pods on DU server 610 has been maintained.

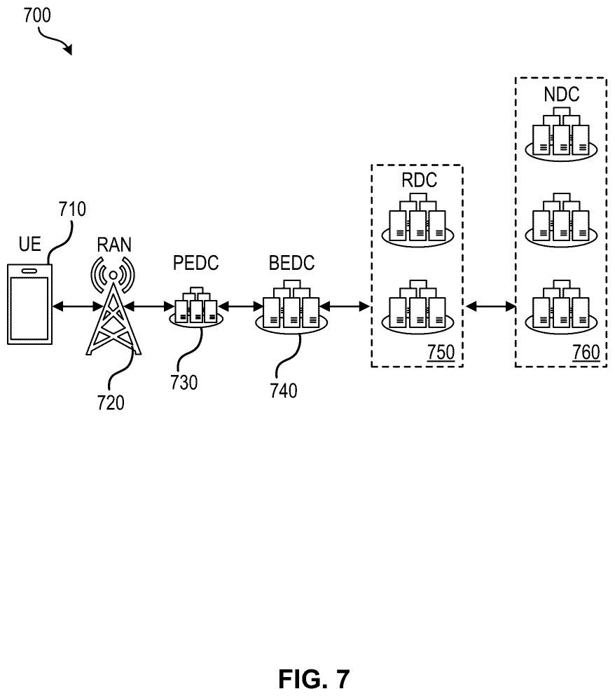

FIG. 7 is an architectural diagram illustrating a telecommunications system 700, according to an embodiment of the present invention. User equipment (UE) 710 (e.g., a mobile phone, a tablet, a laptop computer, etc.) communicates with RAN 720. RAN 720 sends communications to UE 710, as well as from UE 710 into the core carrier network. In some embodiments, communications are sent to/from RAN 720 via a PEDC 730 to provide lower latency. However, in some embodiments, RAN 720 communicates directly with a BEDC 740. BEDCs are typically smaller data centers that are proximate to the populations they serve. BEDCs may break out User Plane Function data traffic (UPF-d) and provide cloud computing resources and cached content to UE 710, such as providing Network Function (NF) application services for gaming, enterprise applications, etc. In certain embodiments, RAN 720 may include an LDC (not shown) that hosts one or more DUs.

The carrier network may provide various NFs and other services. For instance, BEDC 740 may provide cloud computing resources and cached content to UE 710, such as providing NF application services for gaming, enterprise applications, etc. An RDC 750 may provide core network functions, such as UPF for voice traffic (UPF-v) and Short Message Service Function (SMSF or SMF) functionality. A National Data Center (NDC) 760 may provide a Unified Data Repository (UDR) and user verification services, for example. Other network services that may be provided may include, but are not limited to, Internet Protocol (IP) Multimedia Subsystem (IMS)+Telephone Answering Service (TAS) functionality, IP-SM Gateway (IP-SM-GW) functionality (the network functionality that provides the messaging service in the IMS network), Enhanced Serving Mobile Location Center (E-SMLC) functionality, Policy and Charging Rules Function (PCRF) functionality, Mobility Management Entity (MME) functionality, Signaling Gateway (SGW) Control Plane (SGW-C) and User Data Plane (SGW-U) ingress and egress point functionality, Packet Data Network Gateway (PGW) Control Plane (PGW-C) and User Data Plane (PGW-U) ingress and egress point functionality, Home Subscriber Server (HSS) functionality, UPF+PGW-U functionality, Access and Mobility Management Function (AMF), HSS+Unified Data Management (UDM) functionality, SMF+PGW-C functionality, Short Message Service Center (SMSC) functionality, and/or Policy Control Function (PCF) functionality. It should be noted that additional and/or different network functionality may be provided without deviating from the present invention. The various functions in these systems may be performed using dockerized clusters in some embodiments.

BEDC 740 may utilize other data centers for NF authentication services. RDC 750 receives NF authentication requests from BEDC 740. RDC 750 may provide core network functions, such as UPF-v and SMSF. This helps with managing user traffic latency, for instance. However, RDC 750 may not perform NF authentication in some embodiments.

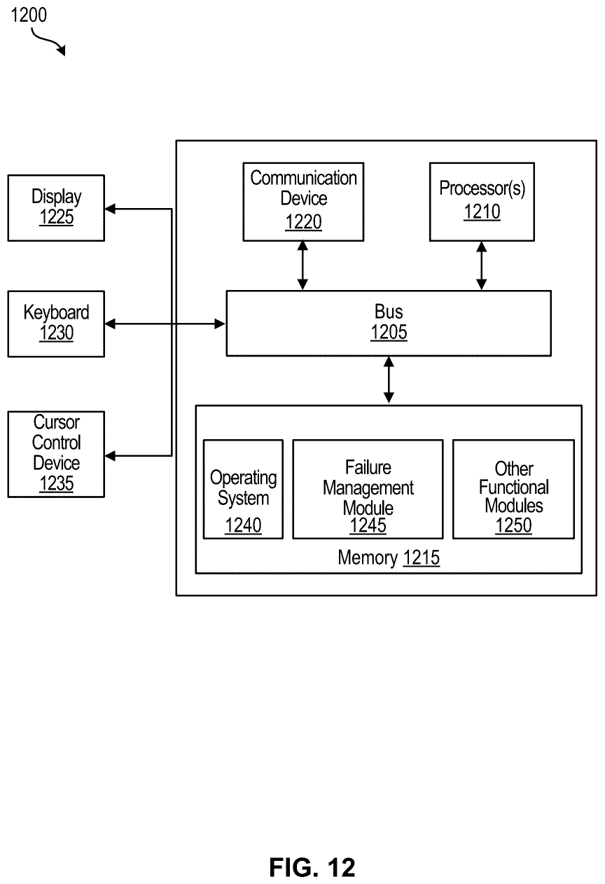

From RDC 750, NF authentication requests may be sent to NDC 760, which may be located far away from UE 710, RAN 720, PEDC 730, BEDC 740, and RDC 750. NDC 760 may provide a UDR, and user verification may be performed at NDC 760. UPF-d, UPF-v, SMSF, UDR, and user verification may be performed by dockerized computing clusters. Once the user of UE 710 is verified and authorized hardware is confirmed via NDC 760, NF authentication is completed by UE 710 and the NF is authorized. UE 710 is then able to access and use the respective application or service via PEDC 730 or BEDC 740. In some embodiments, UE 710 and/or computing systems of RAN 720, PEDC 730, BEDC 740, RDC 750, and/or NDC 760 may be computing system 1200 of FIG. 12. In embodiments where an orchestrator is used, the orchestrator may be located in RAN 720, PEDC 730, BEDC 740, RDC 750, or NDC 760.

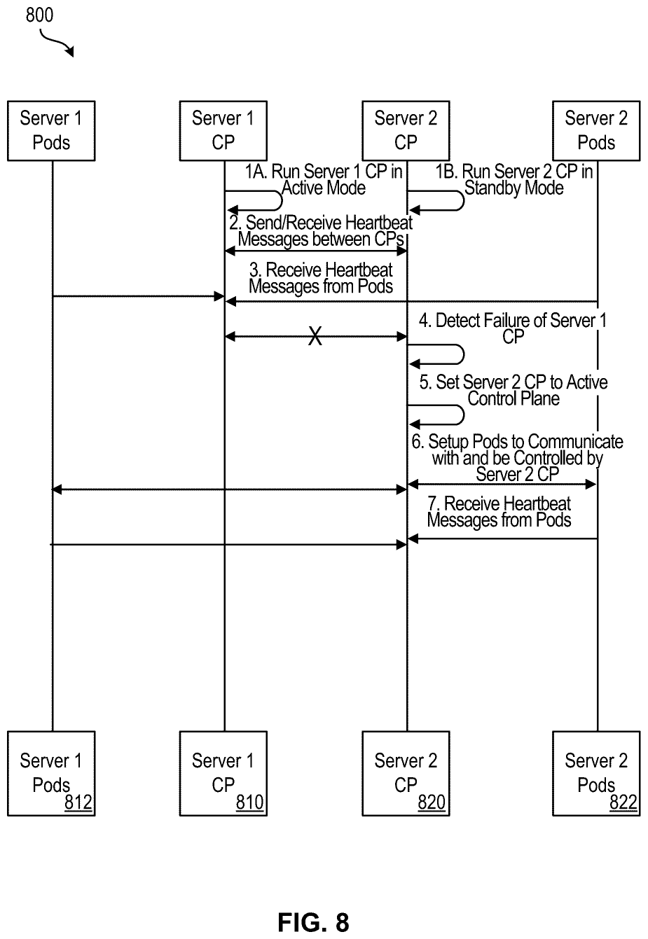

FIG. 8 is a flow diagram illustrating a process 800 for performing cluster failure management in a two server cluster when an active control plane goes down, according to an embodiment of the present invention. The process begins with running a control plane 810 on a first server in active mode and running a control plane 820 on a second server in standby mode. Control plane 810 manages pods 812 on the first server and pods 822 on the second server. Control plane 810 and control plane 820 exchange heartbeat messages. Pods 812, 822 also send heartbeat messages to control plane 810.

In this scenario, second control plane 820 no longer receives heartbeat messages from control plane 810. Control plane 820 then takes over as the active control plane and instructs pods 812, 822 to communicate with control plane 820 instead. Control plane 820 then receives heartbeat messages from pods 812, 822 and controls their operations accordingly.

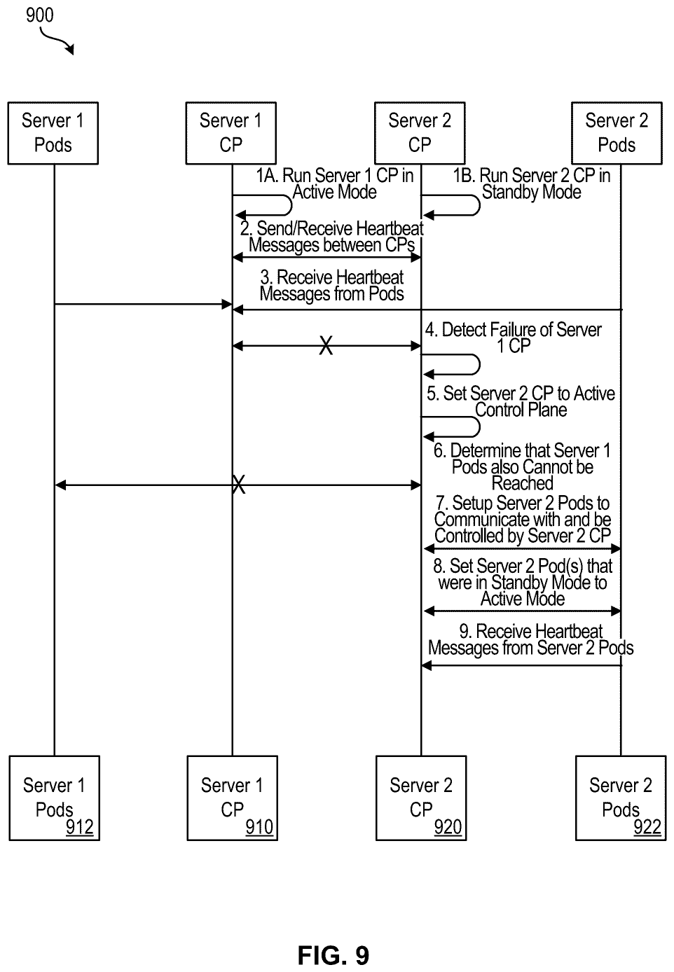

FIG. 9 is a flow diagram illustrating a process 900 for performing cluster failure management in a two server cluster when a server with an active control plane goes down, according to an embodiment of the present invention. The steps of process 800 are similar to those of process 900 up until detecting that the heartbeat messages from control plane 910 are not received by control plane 920 and setting control plane 920 to the active control plane. Control plane 920 then determines that pods 912 also cannot be reached. In other words, control plane 920 is not receiving heartbeat messages from control plane 910 or from pods 912. Control plane 920 then sets up pods 922 to communicate with and be controlled by control plane 920, as well as deploys and/or actives replicas of pods 912 on the same server as pods 922.

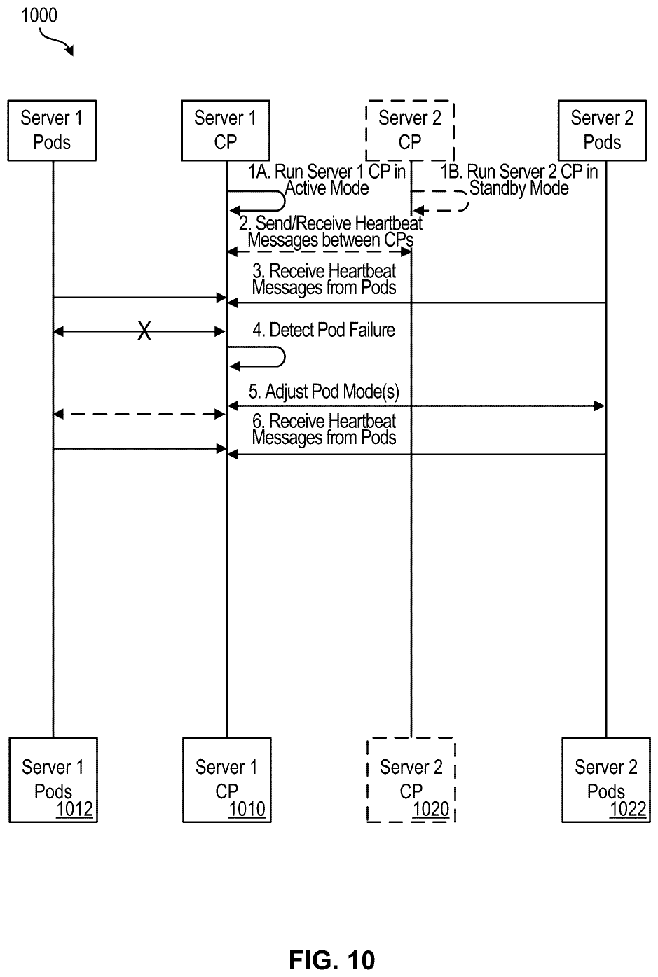

FIG. 10 is a flow diagram illustrating a process 1000 for performing cluster failure management in a two server cluster when an active pod goes down, according to an embodiment of the present invention. Control plane 1020 may not be present in single control plane embodiments where control plane 1010 manages pods 1012, 1022 on two servers. If present, control plane 1020 is set to run in standby mode and send/receives heartbeat messages to/from active control plane 1010.

Control plane 1010 receives heartbeat messages from pods 1012, 1022. However, in this scenario, an active pod of pods 1012 fails. This may be detected by control plane 1010 not receiving heartbeat messages from the failed pod, for example. Control plane 1010 then deploys and/or activates a corresponding replica pod of pods 1022 to perform the functions of the failed pod. Control plane 1010 may also instruct other pods of pods 1012, 1022 to change to active or standby mode to balance processing and memory resources between the servers, for example. Control plane 1010 then continues to receive the heartbeat messages from pods 1012, 1022 and monitor their operation.

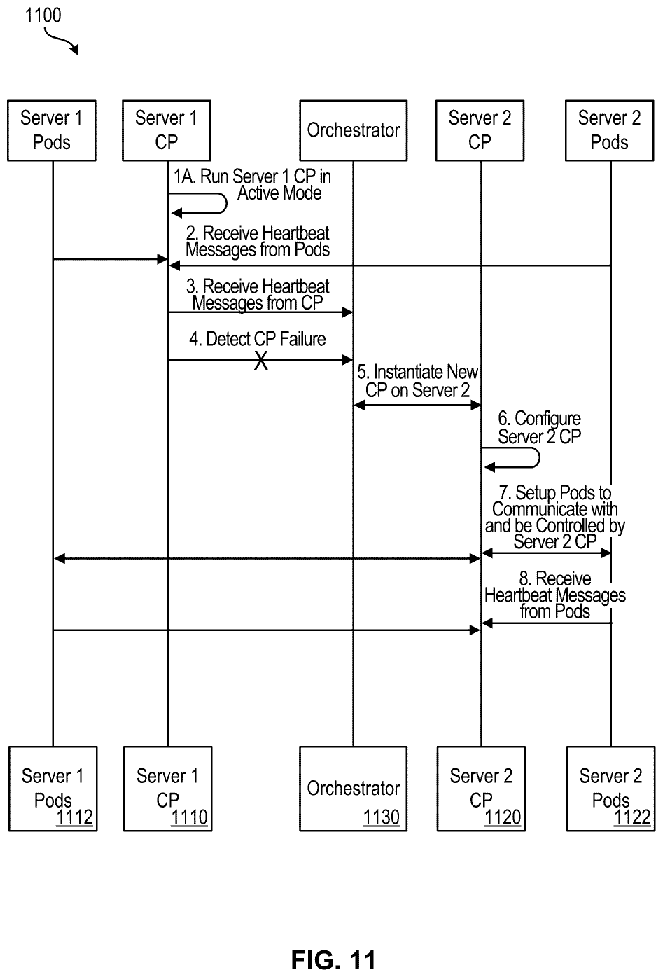

FIG. 11 is a flow diagram illustrating a process 1100 for performing cluster failure management in a two server cluster with a single control plane using an orchestrator, according to an embodiment of the present invention. Control plane 1110 of a first server is running in active mode and controlling pods 1112, 1122 of the first server and a second server, respectively. Control plane 1110 also sends heartbeat messages to an orchestrator 1130.

Orchestrator 1130 stops receiving heartbeat messages from control plane 1110 and determines that a failure has occurred. Orchestrator 1130 then attempts to recover from this failure by instantiating a control plane 1120 to take the place of control plane 1110 on the second server. Orchestrator 1130 has topology information pertaining to the cell site, the configuration of the DU, etc. Orchestrator 1130 also maintains the configurations for the pods and the control plane for that DU. Orchestrator 1130 may configure control plane 1120 with this topology. Control plane 1120 is configured accordingly, sets up connectivity to pods 1112, 1122 based on the information provided by orchestrator 1130, and manages pods 1112, 1122 in place of failed control plane 1110. Control plane 1120 then receives heartbeat messages from pods 1112, 1122 and takes over control plane operations.

FIG. 12 is an architectural diagram illustrating a computing system 1200 configured for operation in a cluster failure management system, according to an embodiment of the present invention. In some embodiments, computing system 1200 may be one or more of the computing systems depicted and/or described herein, such as a DU server, an orchestrator server, another carrier network server or computing system, etc. Computing system 1200 includes a bus 1205 or other communication mechanism for communicating information, and processor(s) 1210 coupled to bus 1205 for processing information. Processor(s) 1210 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 1210 may also have multiple processing cores, and at least some of the cores may be configured to perform specific functions. Multi-parallel processing may be used in some embodiments. In certain embodiments, at least one of processor(s) 1210 may be a neuromorphic circuit that includes processing elements that mimic biological neurons. In some embodiments, neuromorphic circuits may not require the typical components of a Von Neumann computing architecture.

Computing system 1200 further includes memory 1215 for storing information and instructions to be executed by processor(s) 1210. Memory 1215 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 1210 and may include volatile media, non-volatile media, or both. The media may also be removable, non-removable, or both.

Additionally, computing system 1200 includes a communication device 1220, such as a transceiver, to provide access to a communications network via a wireless and/or wired connection. In some embodiments, communication device 1220 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 1220 may include one or more antennas that are singular, arrayed, phased, switched, beamforming, beamsteering, a combination thereof, and or any other antenna configuration without deviating from the scope of the invention.

Processor(s) 1210 are further coupled via bus 1205 to a display 1225, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 1225 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 1230 and a cursor control device 1235, such as a computer mouse, a touchpad, etc., are further coupled to bus 1205 to enable a user to interface with computing system 1200. However, in certain embodiments, a physical keyboard and mouse may not be present, and the user may interact with the device solely through display 1225 and/or a touchpad (not shown). Any type and combination of input devices may be used as a matter of design choice. In certain embodiments, no physical input device and/or display is present. For instance, the user may interact with computing system 1200 remotely via another computing system in communication therewith, or computing system 1200 may operate autonomously.

Memory 1215 stores software modules that provide functionality when executed by processor(s) 1210. The modules include an operating system 1240 for computing system 1200. The modules further include a failure management module 1245 that is configured to perform all or part of the processes described herein or derivatives thereof. Computing system 1200 may include one or more additional functional modules 1250 that include additional functionality.

One skilled in the art will appreciate that a “computing system” could be embodied as a server, an embedded computing system, a personal computer, a console, a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

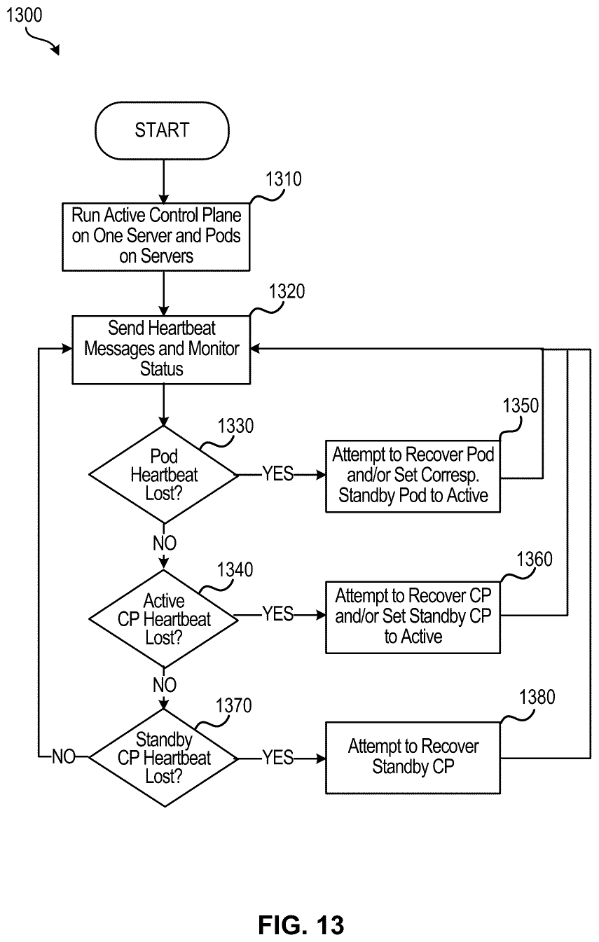

FIG. 13 is a flowchart illustrating a process 1300 for performing cluster failure management in a two server cluster with two control planes, according to an embodiment of the present invention. The process begins with running an active control plane and a standby control plane on respective servers, as well as running pods, at 1310. The active control plane manages the pods on both servers. The control planes send heartbeat messages to one another and the pods send heartbeat messages to the active control plane at 1320.

If heartbeat messages for a pod are no longer received at 1330, an attempt is made to recover the pod on the respective server by instantiating a new instance thereof and/or a corresponding replica of the pod on the other server at 1340. If the standby control plane no longer receives heartbeat messages from the active control plane at 1350, an attempt is made to recover the active control plane on the respective server by instantiating a new instance thereof and/or the standby control plane on the other server is set to active mode at 1360. If the active control plane no longer receives heartbeat messages from the standby control plane at 1370, an attempt is made to recover the standby control plane on the respective server by instantiating a new instance thereof at 1380.

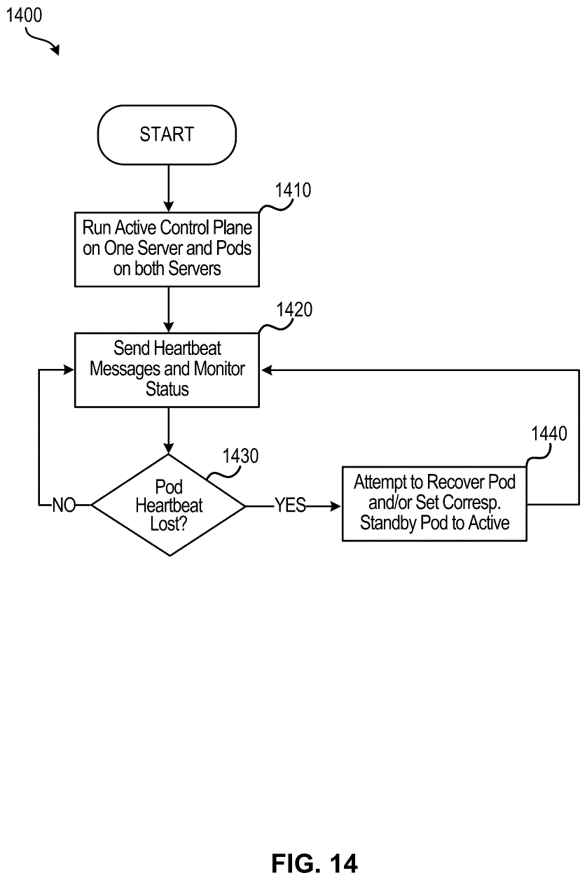

FIG. 14 is a flowchart illustrating a process 1400 for performing cluster failure management in a two server cluster with a single control plane, according to an embodiment of the present invention. The process begins with running an active control plane on one of the servers, as well as running pods on both servers, at 1410. The active control plane manages the pods on both servers. The pods send heartbeat messages to the active control plane at 1420. If heartbeat messages for a pod are no longer received at 1430, an attempt is made to recover the pod on the respective server by instantiating a new instance thereof and/or a corresponding standby pod on the other server is set to active mode at 1440.

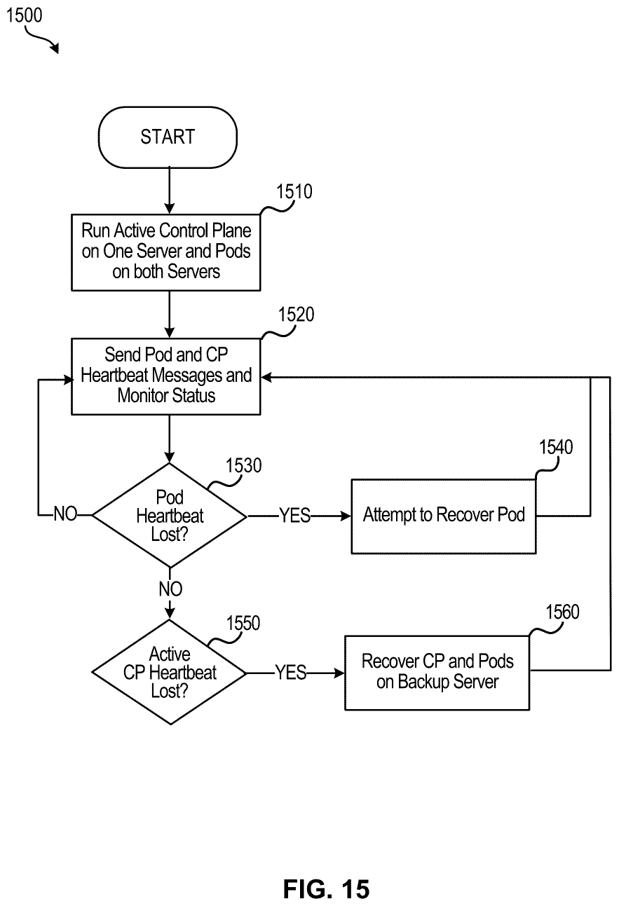

FIG. 15 is a flowchart illustrating a process 1500 for performing cluster failure management in a two server cluster with a single control plane using an orchestrator, according to an embodiment of the present invention. The process begins with running an active control plane on one of the servers, as well as running pods on both servers, at 1510. The active control plane manages the pods on both servers. The pods send heartbeat messages to the active control plane and the active control plane sends heartbeat messages to an orchestrator application at 1520.

If heartbeat messages for a pod are no longer received at 1530, an attempt is made to recover the pod on the respective server by instantiating a new instance thereof and/or a corresponding standby pod on the other server is set to active mode at 1540. If the orchestrator application no longer receives heartbeat messages from the active control plane at 1550, however, an attempt is made by the orchestrator application to recover the active control plane on the respective server by instantiating a new instance thereof and/or the active control plane is instantiated on the other server at 1560. The process then returns to step 1520, where the new control plane monitors the pods and the orchestrator application monitors the new control plane.

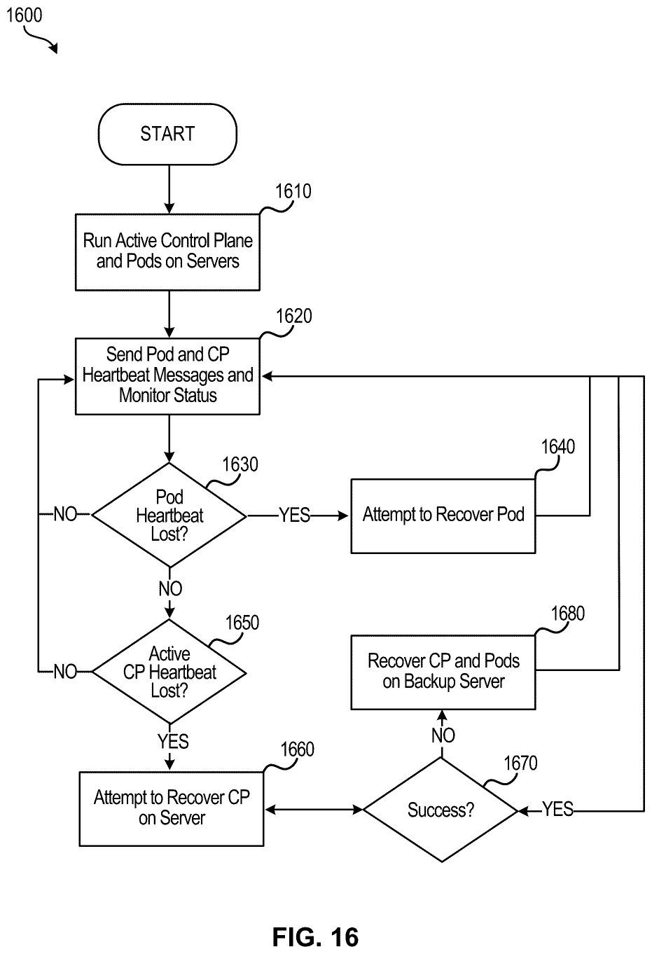

FIG. 16 is a flowchart illustrating a process 1600 for performing cluster failure management in a single server cluster with a single control plane using an orchestrator, according to an embodiment of the present invention. The process begins with running an active control plane and pods on the server at 1610. The pods send heartbeat messages to the active control plane and the active control plane sends heartbeat messages to an orchestrator application at 1620.

If heartbeat messages for a pod are no longer received at 1630, an attempt is made to recover the pod on the server by instantiating a new instance thereof at 1640. If the standby control plane no longer receives heartbeat messages from the active control plane at 1650, however, an attempt is made by the orchestrator application to recover the active control plane on the server by instantiating a new instance thereof at 1660. If this is not successful at 1670, the orchestrator application recovers the active control plane and pods on a backup server that takes the place of the previous server at 1680.

In processes 800, 900, 1000, 1100, 1300, 1400, 1500, and 1600 of FIGS. 8-11 and 13-16, respectively, a control plane or orchestrator application may determine that a pod or control plane failed by determining that a predetermined number of heartbeat messages were not received, or the heartbeat messages were not received for a period of time. In some embodiments, each pod running on the server(s) is configured to perform the DU functions for 9 cells. In certain two server embodiments, the servers share a persistent volume allocated for the platform. A persistent volume is a piece of storage in the cluster that has been provisioned by an administrator. Persistent volumes are resources in the cluster that have a lifecycle independent of any individual pod that uses the persistent volume. The DU functions performed by the pods may include implementing High Physical, MAC, and RLC protocols for the respective cells of the pods.

The process steps performed in FIGS. 8-11 and 13-16 may be performed by computer program(s), encoding instructions for the processor(s) to perform at least part of the process(es) described in FIGS. 8-11 and 13-16, in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 1210 of computing system 1200 of FIG. 12) to implement all or part of the process steps described in FIGS. 8-11 and 13-16, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed.

Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A cellular network, comprising:
a first radio unit configured to support a first cell of the cellular network;
a second radio unit configured to support a second cell of the cellular network; and
a server system in communication with the first radio unit and the second radio unit, the server system comprising a first server and a second server, wherein:
a first pod configured to act as a first distributed unit for the first radio unit is active on the first server and instantiated on the second server;
a second pod configured to act as a second distributed unit for the second radio unit is instantiated on the first server and active on the second server;
a control plane is executing on the first server, the control plane configured to manage execution of the first pod and the second pod by the first server and the second server;
the control plane activates the first pod on the second server in response to determining that the first pod is no longer active on the first server; and
the control plane activates the second pod on the first server in response to determining that the second pod is no longer active on the second server.

2. The cellular network of claim 1, further comprising:
a public cloud-computing platform comprising a plurality of centralized units, wherein the server system is communicatively connected via a network with the public cloud-computing platform.

3. The cellular network of claim 2, wherein the public cloud-computing platform further comprises a network core that manages network functions for the cellular network.

4. The cellular network of claim 1, wherein the control plane determines that a pod is no longer active on a server in response to determining that a predefined number of heartbeat messages were not received from the pod, that the heartbeat messages were not received for a predefined amount of time, or both.

5. The cellular network of claim 1, wherein the server system shares a persistent volume.

6. The cellular network of claim 1, wherein:
in response to determining that the first pod is no longer active on the first server, the control plane further deactivates the second pod on the second server and activates the second pod on the first server.

7. The cellular network of claim 1, wherein:
the control plane activates the first pod on the second server in further response to determining that the first pod cannot be reactivated on the first server; and
the control plane activates the second pod on the first server in further response to determining that the second pod cannot be reactivated on the second server.

8. The cellular network of claim 1, wherein:
the control plane executing on the first server is a first instance;
a second instance of the control plane is executing in standby on the second server;
the second instance of the control plane monitors execution of the control plane on the first server; and
the second instance of the control plane begins to manage the execution of the first pod and the second pod in response to determining that the first instance of the control plane is no longer executing on the first server.

9. The cellular network of claim 8, wherein:
the second instance of the control plane activates the first pod on the second server in response to determining that the first server is no longer available.

10. The cellular network of claim 8, wherein:
the first instance of the control plane monitors execution of the second instance of the control plane on the second server; and
the first instance of the control plane executes a new instance of the control plane on the second server in response to determining that the second instance of the control plane is no longer executing on the second server.

11. The cellular network of claim 1, further comprising:
an orchestration server system running an orchestrator application configured to monitor execution of the control plane on the first server, wherein the orchestrator application instantiates a copy of the control plane on the second server in response to determining that the control plane is no longer executing on the first server.

12. The cellular network of claim 11, wherein:
the orchestrator application instantiates the copy of the control plane on the second server in further response to determining that a new instance of the control plane cannot be executed on the first server.

13. The cellular network of claim 11, wherein:
the orchestrator application activates the first pod on the second server in response to determining that the first server is no longer available.

14. The cellular network of claim 1, wherein the first server and the second server are virtual machines executed by the server system.

15. A method for managing distributed units in a cellular network, the method comprising:
operating a first radio unit to support a first cell of the cellular network;
operating a second radio unit to support a second cell of the cellular network;
instantiating, on a cloud-computing platform, a plurality of centralized units;
operating a server system comprising a first server, a second server, and a radio unit interface, wherein:
the first radio unit and the second radio unit are connected to the radio unit interface of the server system; and
the server system is connected with the cloud-computing platform via a network;
executing a first pod on the first server, wherein the first pod executes a first distributed unit software package that configures the first pod to transmit data between the first radio unit and the plurality of centralized units via the radio unit interface;
instantiating the first pod in standby on the second server;
executing a second pod on the second server, wherein the second pod executes a second distributed unit software package that configures the second pod to transmit data between the second radio unit and the plurality of centralized units via the radio unit interface;
instantiating the second pod in standby on the first server; and
executing a control plane on the first server, wherein:
the control plane manages execution of the first pod and the second pod;
the control plane activates the first pod on the second server in response to determining that the first pod is no longer executing on the first server; and
the control plane activates the second pod on the first server in response to determining that the second pod is no longer executing on the second server.

16. The method for managing distributed units in a cellular network of claim 15, wherein:
in response to determining that the first pod is no longer active on the first server, the control plane further deactivates the second pod on the second server and activates the second pod on the first server.

17. The method for managing distributed units in a cellular network of claim 15, further comprising:
operating an orchestration server system running an orchestrator application, wherein the orchestrator application monitors execution of the control plane on the first server and instantiates a copy of the control plane on the second server in response to determining that the control plane is no longer executing on the first server.

18. A distributed unit, comprising:
a server system in communication with:
a first radio unit configured to support a first cell of a cellular network; and
a second radio unit configured to support a second cell of the cellular network;
wherein the server system comprises a first server and a second server, and wherein:
a first pod configured to act as a first distributed unit for the first radio unit is active on the first server and instantiated on the second server;
a second pod configured to act as a second distributed unit for the second radio unit is instantiated on the first server and active on the second server;
a control plane configured to manage execution of the first pod and the second pod by the first server and the second server is executing on the first server;
the control plane activates the first pod on the second server in response to determining that the first pod is no longer active on the first server; and
the control plane activates the second pod on the first server in response to determining that the second pod is no longer active on the second server.

19. The cellular network of claim 18, wherein the first server and the second server are virtual machines executed by the server system.

20. The cellular network of claim 18, wherein:
the control plane activates the first pod on the second server in further response to determining that the first pod cannot be reactivated on the first server; and
the control plane activates the second pod on the first server in further response to determining that the second pod cannot be reactivated on the second server.
